(19) United States
(12) Patent Application Publication
(10) Pub. No.: US 2025/0356113 A1
(43) Pub. Date: Nov. 20, 2025

(54) ARTIFICIAL-INTELLIGENCE ("AI")-BASED AUTOFILL FOR DOCUMENT PREPARATION

(71) Applicant: Dolphin Care Bina Melachotit Ltd., Jerusalem (IL)

(72) Inventors: Dina Yankelewitz, Jerusalem (IL); Leah Faust, Jerusalem (IL); Rochel Feinroth, Jerusalem (IL); Rivka Yehudis Feldman, Jerusalem (IL); Gila Shoshana Friedman, Jerusalem (IL); Toby Margulies, Jerusalem (IL); Mirel Glejser, Jerusalem (IL); Rebecca Goldblum, Jerusalem (IL); Chana Leah Greenes, Jerusalem (IL); Sara Deitz, Jerusalem (IL); Leah Itzinger, Jerusalem (IL); Hinda Japha, Jerusalem (IL); Chaya Kosowsky, Jerusalem (IL); Rivky Moskovits, Jerusalem (IL); Eve Orlik, Jerusalem (IL); Shoshana Pasternak, Jerusalem (IL); Tova Peterson, Jerusalem (IL); Liebe Roberts, Jerusalem (IL); Ruchama Rubenstein, Jerusalem (IL); Yocheved Kass, Miami, FL (US); Shoshana Soloveitchik, Jerusalem (IL); Hadassa Taller, Kiryat Sefer (IL); Rifka Wassertheil, Jerusalem (IL); Channah Rivka Raikhman, Beit Shemesh (IL); Basya Ettel Witkin, Jerusalem (IL); Batsheva Wolpin, Beit Shemesh (IL); Elinor Nisanov, Far Rockaway, NY (US); Sarah Zahn, Jerusalem (IL); Shaindel Ziskind, Jerusalem (IL); Frances Hill, Jerusalem (IL); Rochel Rand, Jerusalem (IL); Eve Post, Jerusalem (IL); Nicole Seinfeld, Jerusalem (IL); Dina Breski, Jerusalem (IL); Nechama Bromberg, Jerusalem (IL); Betty Friedman, Jerusalem (IL); Rachel Rothschild, Jerusalem (IL); Dvora Schwartzman, Jerusalem (IL); Ronit Kitay, Jerusalem (IL); Miryam Gorelick, Jerusalem (IL); Devorah Sachs, Jerusalem (IL); Hinda Rachel Lichtenstein, Jerusalem (IL); Naomi Miller, Jerusalem (IL); Sarah Ledereich, Jerusalem (IL)

(21) Appl. No.: 19/209,653

(22) Filed: May 15, 2025

Related U.S. Application Data
(60) Provisional application No. 63/648,340, filed on May 16, 2024.

(51) Int. Cl. G06F 40/174; G06F 16/93

(52) U.S. Cl. CPC G06F 40/174; G06F 16/93

(57) ABSTRACT

An AI-based autofill system for document preparation including a browser and a browser extension application may be provided. The browser may display an interactive document. The browser extension may receive a login request from an entity, authenticate the request and instantiate a continual electronic communication link to a database partition storing entity documents. The application may auto-recognize a document type assigned to the document, select an autofill process corresponding to the document type and instantiate an AI engine-based autofill process to autofill fillable options within the document. The engine may retrieve, from the entity documents, a first data segment applicable to a first option included in the fillable options. The engine may execute AI algorithms to convert the first data segment to a second data segment ingestible by the first option. The engine may autofill the first option with the second data segment.

### CROSS-REFERENCE TO RELATED APPLICATION

This application is a non-provisional application of U.S. Provisional Patent Application No. 63/648,340 filed May 16, 2024 entitled “ARTIFICIAL-INTELLIGENCE (“AI”)-BASED AUTOFILL FOR DOCUMENT PREPARATION” which is hereby incorporated by reference herein in its entirety.

### FIELD OF TECHNOLOGY

Aspects of the disclosure relate to artificial intelligence.

### BACKGROUND OF THE DISCLOSURE

Many entities are required to complete documents for various purposes, such as, for example, completing documents for other entities (e.g., vendors, third-parties and subsidiaries) and document retention policies. Many of these documents have been traditionally completed using a pen and physical paper, and physically mailed to the appropriate recipient and/or physically stored at an entity location.

Recently, electronic mail (email) has moved the industry from using pen and paper to completing documents using electronic interfaces. However, current electronic interfaces mimic the effort required on the part of a document preparer. As such, the electronic interfaces do little more than enable a document preparer to electronically enter—i.e. type—the responses into the electronic version of the document.

It would be desirable for an artificial intelligence (“AI”)-based autofill system for document preparation to be provided. Such a system would preferably interface between a database and the document. Such a system would electronically auto-recognize the document being accessed, communicate with the database, retrieve data relating to the document, package the data in a way that is ingestible by the end user (referred to herein in the alternative as an operator) and display to the end user the packaged data when completing the document. Such an AI-based autofill system would enhance end user experience, verify the data input by the end user and prepare documents that are electronically ingestible by other entities.

### SUMMARY

A front-end process flow for an AI-based autofill for document preparation is provided. The front-end process flow may include displaying an interactive document. The interactive document may be an assessment. The interactive document may be an assessment used in a facility, such as, for example, a skilled nursing facility. The assessment may assess a resident of a skilled nursing facility. The assessment may be transmitted to an appropriate third party, such as, for example, an insurance entity associated with the resident. The interactive document may be displayed in a browser. The browser may operate on a hardware processor and hardware memory.

The front-end process flow may include receiving a login request from an entity. The entity may be in the process of entering data into the interactive document. The entity may be referred to herein, in the alternative as a user. The entity may be a facility member of the skilled nursing facility. The facility member may enter data relating to, or on behalf of, the resident.

The login request may be a request to login to a browser extension application. The browser extension application may operate within the browser. The browser extension application may operate on the browser displaying the interactive document. The browser extension application may operate on one or more hardware processors, hardware memory storage devices, one or more databases, one or more artificial intelligence engines (each artificial intelligence engine may include one or more artificial intelligence models) and any other suitable computing components. The computing components may receive data from the browser extension application, transmit data to the browser extension application, receive data from other source locations, such as databases and/or software applications and transmit data to other source locations, such as database and/or software applications.

The front-end process flow may include authenticating the login request at the browser extension application. Authenticating the login request may involve communicating with one or more databases to verify the login request data input by the entity. The front-end process flow may successfully authenticate the login request.

Upon successful authentication, the front-end process flow may include instantiating a continual electronic communication link between the browser extension application and a database partition assigned to the entity. The user may be a facility member. The entity may be the facility. The entity may be a group of facilities. The entity may be any other suitable entity.

It should be noted that a database may store data relating to multiple entities. As such, the database may be partitioned so that an entity may only retrieve self-relational entity data (data not from other entities or relating to other entities). The database partition may store one or more entity documents in one or more file formats.

The entity documents may, for example, include a doctor's order, a live document hyperlink that links to an assessment within a skilled nursing facility, a progress note, a medication administration record, a treatment administration record, a medical episode document, an external doctor document, a hospital visit record (including emergency room visits and hospital stay records), and an external professional (external to a skilled nursing facility) document. The file formats may be portable document format (“PDF”) files, text files, image files, manipulatable file formats and any other suitable file formats. The entity documents may be processed using optical character recognition (“OCR”) to enable an AI engine read and identify the data stored within the entity documents.

It should be noted that the AI engine may operate with a large language model (“LLM”) to perform one or more executions discussed within the applications. Such executions may include, for example, reading documents and identify the data from the documents.

It should be noted that, in some embodiments, the entity may be a combination entity, for example, the entity may be a facility member and an entity. As such, the database partition may correspond to data relating to the entity and may be accessible by the facility member.

Upon successful authentication, the browser extension application may auto-recognize a document type assigned to the interactive document displayed in the browser. For example, the browser extension application may auto-recognize that the interactive document displayed in the browser may be an assessment.

Upon successful authentication, the browser extension application may auto-tag the interactive document with the document type. Upon successful authentication, the browser extension application may select an autofill process that corresponds to the document type. The autofill process may be selected from a plurality of autofill processes.

Upon successful authentication, the browser extension application may instantiate the autofill process corresponding to the document type. Upon successful authentication, the browser extension application may autofill, by the autofill process executing within the browser extension application, one or more fillable options within the interactive document displayed in the browser.

The autofill process may execute an artificial intelligence engine. Executing the artificial intelligence engine may include retrieving a first data segment from the one or more entity documents stored within the database partition. Executing the artificial intelligence engine may also include executing one or more artificial intelligence algorithms. The one or more artificial intelligence algorithms may electronically convert the first data segment into a second data segment. The second data segment may be ingestible by one of the one or more fillable options. Executing the artificial intelligence engine may also include autofilling the one of the one or more fillable options with the second data segment.

At times, the first data segment may indicate less than an information threshold of relevance to the one of the one or more fillable options. For example, if a fillable option requests a number of times an entity received solid food, and the entity documents do not include any instance of the entity receiving solid food, the first data segment may indicate that there is no current information threshold of relevance to the number of times the entity received solid food. As such, the second data segment may be a negative answer. For example, the second data segment may be zero times, or the entity has not received solid food.

In certain embodiments, the autofilling the one of the one or more fillable options with the second data segment may require electronic approval of the second data segment.

In certain embodiments, the browser extension application may display a selectable option for a pop-up window corresponding to the first data segment. The selectable option may be displayed adjacent to the one of the one or more fillable options. The pop-up window may show a correlation between the first data segment and the second data segment. The one or more documents may be retrieved. The one or more documents may be displayed within the pop-up window. The pop-up window may be electronically displayed to the entity within the browser.

In some embodiments, the one or more entity documents may be converted into a second interactive document. The second interactive document may also be referred to herein as a source document. The second interactive document may include one or more indicators to the first data segment. The second interactive document may include one or more toggle options. The one or more toggle options may auto-reposition the second interactive document to display the one or more indicators.

The second interactive document may be electronically perused by the entity. Electronic perusing may include at least electronic auto-reposition of the second interactive document. Upon electronic perusing of the second interactive document, the second interactive document may enable selection of an electronic reviewed selectable option. The electronic reviewed selectable option may indicate that the second interactive document may have been approved for the first data segment. Upon selection of the electronic reviewed selectable option, the second interactive document may include and/or be tagged with a second indicator. The second indicator may be displayed in a second pop-up window for a second of the one or more fillable options.

At times, autofilling the one or more fillable options with the second data segment may be triggered upon the selection of the selectable option for the pop-up window. Also, at times, autofilling the one of the one or more fillable options with the second data segment may be triggered upon displaying the one or more entity documents within the pop-up window.

In certain embodiments, upon autofilling one of the one or more fillable options, a third indicator adjacent to the one of the one or more fillable options may be auto-generated. The third indicator may display an icon. The icon may be selected from a plurality of stored icons. Selection of the icon may be based on a confidence score assigned by the artificial-intelligence engine to the autofilling of the one of the one or more fillable options. In some embodiments, the icon may include a hover-over capability. When the hover-over capability is triggered by a mouse hover, the hover-over capability may display textual information relating to the selected icon.

At times, the interactive document may require input by the entity for completion. In such embodiments, the system may not automatically complete the interactive document. Rather, the interactive document may be labeled complete upon an active command, such as, for example, selection of a completion button, from the entity.

In certain embodiments, a manager, such as, for example, a facility doctor may be required to electronically sign a completed interactive document in order for the interactive document to be valid. As such, an electronic display and/or alert may be displayed and/or transmitted to a facility doctor. The electronic display and/or alert may include one or interactive documents for review and signature. The electronic display and/or alert may enable the facility doctor to electronically sign the one or more interactive documents.

A front-end process flow for an artificial-intelligence (“AI”)-based auto-selection for document preparation may also be provided.

The front-end process flow may include receiving, at a user interface, a request from an operator to identify one or more time windows in which a document associated with a subject should be completed to maximize resource consumption associated with the document. The time windows may, in certain embodiments, correspond to calendar days. A subject may be referred to herein, in the alternative, as a second user.

The front-end process flow may include electronically perusing, using an AI engine communicating with a database, a plurality of electronic documents stored in the database. The plurality of electronic documents may be associated with the second user. The plurality of electronic documents may include one or more instances relating to one or more specific data elements. The one or more specific data elements may have been previously instructed by, and/or transmitted to, the AI engine by an entity and/or user. The one or more specific data elements may be dynamically identified by the AI engine.

The front-end process flow may include generating, using the AI engine, a list. The list may be a list data structure. The generating may be executed upon identification, within the plurality of electronic documents, of one or more instances relating to the one or more specific data elements. The list may include each of the one or more specific data elements. The list may also include the one or more instances relating to each specific data element included in the one or more specific data elements. The list may also include a timestamp associated with each of the one or more instances.

The front-end process flow may dynamically generate, based on the list, an electronic calendar. The electronic calendar may include one or more indicators corresponding to the one or more time windows in which the document associated with the subject should be completed to maximize resource consumption. The one or more time windows may be dates. The electronic calendar may be displayed on the user interface. The front-end process flow may include auto-selecting, by the AI engine, the one or more time windows in which the document associated with the subject should be completed to maximize resource consumption.

An alert process may be provided. The alert process may involve assigning a repository, virtual machine and/or Amazon Web Services® to the process. The alert process may involve assigning a pipeline to the process.

The alert process may detect available capturable resources by analyzing subject decline in real-time. The alert process may include using artificial-intelligence (“AI”) to proactively search for text, included in source documents, that correspond to subject decline data objects.

Proactively searching for text may include one or more processes, such as, for example, one or more structured query language (“SQL”) stored procedures. The processes may include identifying a facility. The facility may be identified by an identifier and/or abbreviation. The processes may include identifying a list of subjects that completed an assessment within the facility. The processes may include retrieving a most recent assessment for each of the subjects included in the list of subjects. The processes may include outputting data for each subject. The data may be output in JSON, any other suitable format. The data may include a subject identifier, a facility identifier, a date range and any other suitable data.

The source documents may include medication/treatment administration records, progress notes, assessments, doctors orders, care plans, diagnoses, interventions and/or other healthcare documents. The source documents may be in various file formats, such as, for example, portable document format (“PDF”), extensible markup language (“XML”), text, spreadsheet, comma separated value (“CSV”) and any other suitable file formats. The source documents may be manipulated to ensure that data included in the source documents may be accessed. Such manipulations may include optical character recognition (“OCR”).

A subject decline data object may be a data object operable to store data relating to a subject decline. The proactive search may be specific to a subject (per-subject search), specific to a section on an interactive document, such for example, an assessment (per-section search), specific to a group of sections on the interactive document (per-group of sections search) and/or any other suitable search. As such, the proactive search may be specific to a subject and a section. There may be multiple searches operating in parallel for multiple subjects, multiple groups of sections and/or multiple sections.

Upon identification of one or more subject decline data objects, the alert process may include creating a list data structure. The list data structure may include the one or more subject decline data objects. The list data structure may also include linking each subject decline data object to a source document and/or to a specific location within the source document (such as, for example, a textual location). The alert process may include creating a correspondence between the source document and/or specific location within the source document and the subject decline data object. At times, the source document and/or specific location within the source document may be included in the list data structure. The list data structure may include subject decline data objects that correspond to fillable options within an assessment for which a previously provided answer was negative.

The list data structure may be transmitted to a large language model (“LLM”). At times, a list data structure may correspond to a specific section, or group of sections. As such, multiple list data structures may be transmitted to the LLM or a single data structure may be transmitted to the LLM. The LLM may utilize a plurality of guidelines to evaluate whether each subject decline data object stored within the list data structure, or list data structures, are relevant for a fillable option within an interactive document. The LLM may filter out unrelated subject decline data objects. The LLM may identify a correct starting point, which may be a key used to initiate a decision tree workflow. The LLM may output one or more of a plurality of fillable options and/or a correct starting point in the event that one or more of the plurality of fillable options have been located. Exemplary output of the LLM may include a type of source document in which the subject decline data object was located, a subject identifier, a condition associated with the subject and a textual quote from within the source document. At times, conditions associated with the subject may be retrieved from a predetermined enumerated type list and/or or list of conditions. The LLM may output a null output in the event that no fillable options have been located. The textual quote may be matched/corresponded to a most appropriate fillable option based on a set of coding rules. Each quote may be labeled codable or uncodable based on a set of standards. Uncodable alerts may be terminated.

In the event that the LLM outputs one or more of the plurality of options and/or a correct starting point, the decision tree workflow may be initiated. The decision tree workflow may assign a score to outputs provided by the LLM. The score may be compared to a score previously assigned to a subject associated with the outputs.

When the score shows a positive increase (the assigned score is greater than the previous score), an alert may be initiated. The alert may utilize Kafka, simple q system on an Amazon Web Services® or any other suitable computing system or network.

The alert may be tagged as ordered or administered. Ordered data may be data that has been directed, however not necessarily implemented. Administered data may be data that has been implemented. At times, administered data may provide a higher level of information to a viewer of the alert.

The alert may include instructions for viewer of the alert. The alert may be assigned a date range. As such, a separate alert may not be initiated each day. Each alert may be linked to one or more source documents.

Other alerts may also be provided. Such alerts may include identifying treatable conditions based on identified conditions. Such alerts may include quality measure alerts. Quality measure alerts may identify conditions that affect quality measures. Such alerts may identify other conditions that may be used to forecast quality measure changes.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure;

FIG. 6 shows yet another illustrative diagram in accordance with principles of the disclosure;

FIG. 7 shows still another illustrative diagram in accordance with principles of the disclosure;

FIG. 8 shows yet another illustrative diagram in accordance with principles of the disclosure;

FIG. 9 shows still another illustrative diagram in accordance with principles of the disclosure;

FIG. 10 shows yet another illustrative diagram in accordance with principles of the disclosure;

FIG. 11 shows still another illustrative diagram in accordance with principles of the disclosure;

FIG. 12 shows yet another illustrative diagram in accordance with principles of the disclosure;

FIG. 13 shows still another illustrative diagram in accordance with principles of the disclosure;

FIG. 14 shows yet another illustrative diagram in accordance with principles of the disclosure;

FIG. 15 shows still another illustrative diagram in accordance with principles of the disclosure;

FIG. 16 shows yet another illustrative diagram in accordance with principles of the disclosure;

FIG. 17 shows still another illustrative diagram in accordance with principles of the disclosure;

FIG. 18 shows yet another illustrative diagram in accordance with principles of the disclosure;

FIG. 19 shows still another illustrative diagram in accordance with principles of the disclosure;

FIG. 20 shows yet another illustrative diagram in accordance with principles of the disclosure;

FIG. 21 shows still another illustrative diagram in accordance with principles of the disclosure;

FIG. 22 shows yet another illustrative diagram in accordance with principles of the disclosure;

FIG. 23 shows still another illustrative diagram in accordance with principles of the disclosure;

FIG. 24 shows yet another illustrative diagram in accordance with principles of the disclosure;

FIG. 25 shows still another illustrative diagram in accordance with principles of the disclosure;

FIG. 26 shows yet another illustrative diagram in accordance with principles of the disclosure;

FIG. 27 shows still another illustrative diagram in accordance with principles of the disclosure;

FIG. 28 shows yet another illustrative diagram in accordance with principles of the disclosure;

FIG. 29 shows still another illustrative diagram in accordance with principles of the disclosure;

FIG. 30 shows yet another illustrative diagram in accordance with principles of the disclosure;

FIG. 31 shows still another illustrative diagram in accordance with principles of the disclosure;

FIG. 32 shows yet another illustrative diagram in accordance with principles of the disclosure;

FIG. 33 shows still another illustrative diagram in accordance with principles of the disclosure;

FIG. 34 shows yet another illustrative diagram in accordance with principles of the disclosure;

FIG. 35 shows still another illustrative diagram in accordance with principles of the disclosure;

FIG. 36 shows yet another illustrative diagram in accordance with principles of the disclosure;

FIG. 37 shows still another illustrative diagram in accordance with principles of the disclosure;

FIG. 38 shows yet another illustrative diagram in accordance with principles of the disclosure; and

FIGS. 39A and 39B show an illustrative flow chart in accordance with principles of the disclosure.

### DETAILED DESCRIPTION OF THE DISCLOSURE

Apparatus, methods and systems for an artificial-intelligence (“AI”)-based autofill for document preparation is provided.

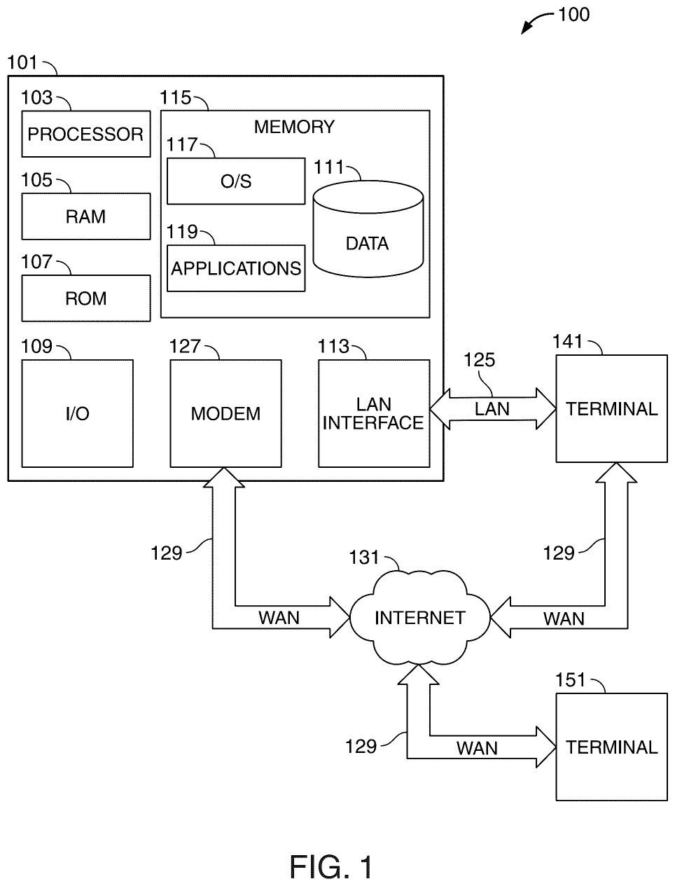

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smart phone, or any other suitable computing device. Elements of system 100, including computer 101, may be used to implement various aspects of the systems and methods disclosed herein. Each of the user telephones, mobile devices, user devices, databases and any other part of the disclosure may include some or all of apparatus included in system 100.

Computer 101 may have a processor 103 for controlling the operation of the device and its associated components and may include Random Access Memory (“RAM”) 105, Read Only Memory (“ROM”) 107, input/output circuit 109 and a non-transitory or non-volatile memory 115. Machine-readable memory may be configured to store information in machine-readable data structures. The processor 103 may also execute all software executing on the computer—e.g., the operating system and/or voice recognition software. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of the system 100. Memory 115 may also store videos, text and/or audio assistance files. nodes, servers, computing devices, User telephones, user devices, databases and any other suitable computing devices as disclosed herein may have one or more features in common with Memory 115. The data stored in Memory 115 may also be stored in cache memory, or any other suitable memory.

Input/output (“I/O”) module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. When used in a LAN networking environment, computer 101 is connected to LAN 125 through a LAN interface or adapter 113. When used in a Wide Area Network (“WAN”) networking environment, computer 101 may include a modem 127 or other means for establishing communications over WAN 129, such as Internet 131. Connections between System 100 and Terminals 151 and/or 141 may be used for the communication between different nodes and systems within the disclosure.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”) and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may utilize one or more decisioning processes.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 111 and any other suitable information, may be stored in memory 115. One or more of applications 119 may include one or more algorithms that may be used to implement features of the disclosure comprising the transmission, storage, and transmitting of data and/or any other tasks described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, tablet, smartphone, or any other computing system for receiving, storing, transmitting and/or displaying relevant information. Terminal 151 and/or terminal 141 may be one or more data sources or a calling source. Terminals 151 and 141 may have one or more features in common with apparatus 101. Terminals 151 and 141 may be identical to system 100 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

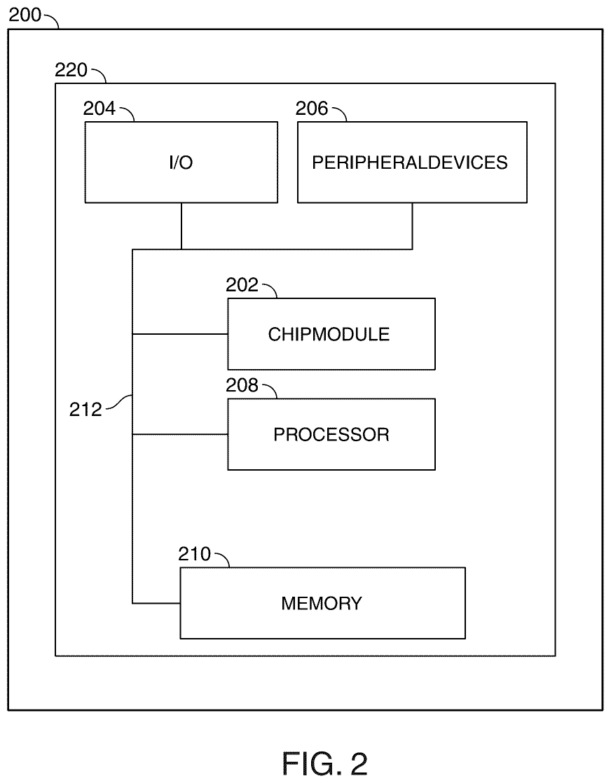

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

Systems may include autofilling forms using an overlay of exemplary management software. Systems may enable substantially seamless integration between the suggestions provided by the overlay and user-completable forms.

Systems may receive data from various sources. Systems may manipulate and format the data to enable the data to be ingested by a first AI model. Systems, using the first AI model, may suggest answers to questions within a document based on the culled data. The suggested answers may include answers to selected multiple-choice questions, fill-in answers and/or any other suitable answers.

When the suggested answer is a negative answer, such as a null response, systems may complete processing for the question that is associated with a negative answer. When the suggested answer is a positive answer, such as a yes answer, systems may present the source of the answer to system operator.

In order to present the source of the answer to the system operator (in the alternative, the operator), systems may re-input the data culled for the question into a second AI model. The second AI model may identify the original source documents (that do not include manipulations performed by a portion of the system). The second AI model may present the source documents to the operator. At times, prior to presenting the source documents to the operator, the source documents may be annotated, such as by highlighting, or by insertion of links, in order to enable the operator to efficiently identify a source of the positive answer.

There may be a backend to the application. The backend may communicate with the sources stored within the database. The backend may be written using software, such as, for example, Python and Django.

The database may be a structured query language (“SQL”) server or any other suitable server or database.

There may be a front end to the application. The front end may include a web application and/or browser extension. The front end may communicate between the operator and the backend. The front end may be written using React framework of using some other suitable framework.

### Front-End-Illustrative Process Flow

1. An operator may log into a browser extension application.
2. The browser extension application may authenticate the operator.
3. The browser extension application may recognize and identify the type of the document displayed in the browser. The document may include a questionnaire. The document may be a standardized assessment. The document may be a standardized assessment for residents in public living facilities, such as assisted living facilities. It should be noted that one or more separate AI models may be used for each question and/or fillable option.
4. The browser extension application uses data from multiple sources to fill in the document without—i.e., preferably independent of—operator intervention. Filling in the document may include suggesting certain answers and/or selecting certain answers on the document. The data from the multiple sources may have been stored in a database, such as a structured query language (“SQL”) server.

At times, PDF documents may be stored in Amazon® web services (“AWS”) buckets. Data may also be stored in SQL server. The SQL server data may be stored within a cloud environment. The SQL server data may also be stored in a server farm on an entity premises.
5. An indicator may be displayed next to the suggested answer. For example, a suggested answer to a multiple-choice question may be highlighted. In another example, a suggested answer to a non-multiple-choice question, such as a fill-in question, may be autofilled. An icon, indicating that an answer has been selected or filled-in by the application, may be placed adjacent to the question and/or the selected or filled-in answer. A checkmark may also be placed adjacent to the question and/or the selected or filled-in answer.
6. The application may give the operator the option to confirm and/or change the auto-generated answer. Selection of the corresponding checkmark may confirm the auto-generated answer. Once the auto-generated answer has been confirmed, the indicator and/or the checkmark may change appearance, such as colors.
7. The application may, in certain embodiments, not disrupt changed answers.
8. If an operator changes an answer, the application may provide an option to document the decision without having to leave the application and/or the management software. As such, if an operator selects a response different from the suggested response, a pop-up may be prompted by the extension. The pop-up may request justification for a different selection made. The justification may be stored in the database. The justification may be retrievable at a later date. A supervisor, such as a manager, may set up whether or not an operator has the option to ignore the pop-up and elect not to provide a justification.

The justification may enable operators to document why they chose to change a generated answer. Managers may be able to view one or more of the justifications and understand why an operator changed a generated answer.

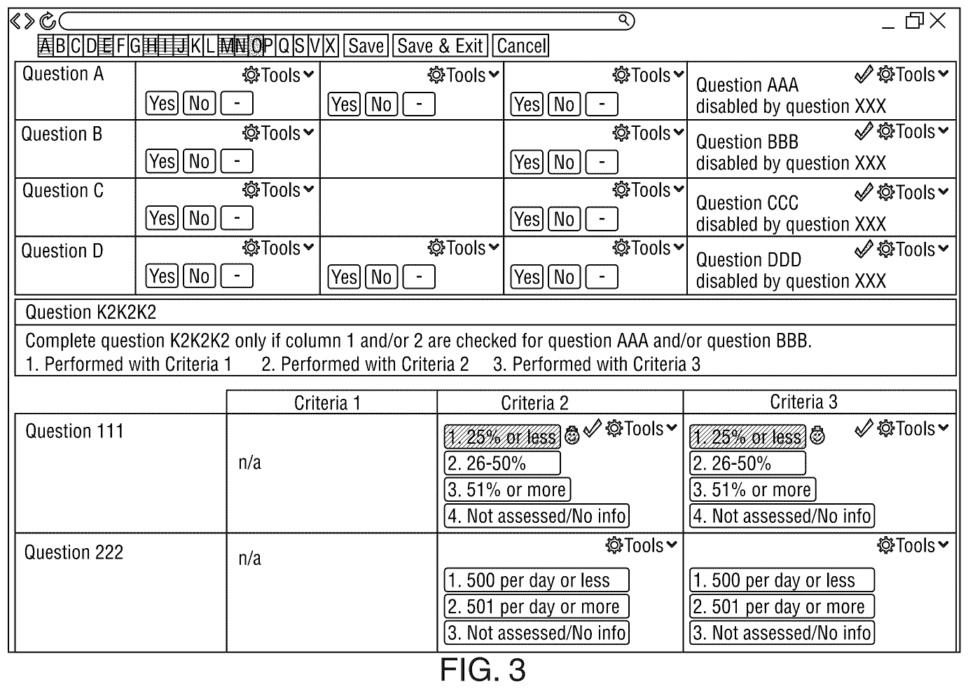

FIG. 3 shows an exemplary questionnaire. As shown in FIG. 3, suggested answers to questions may be generated by the application. The application may indicate which answers to be selected and/or autofilled.

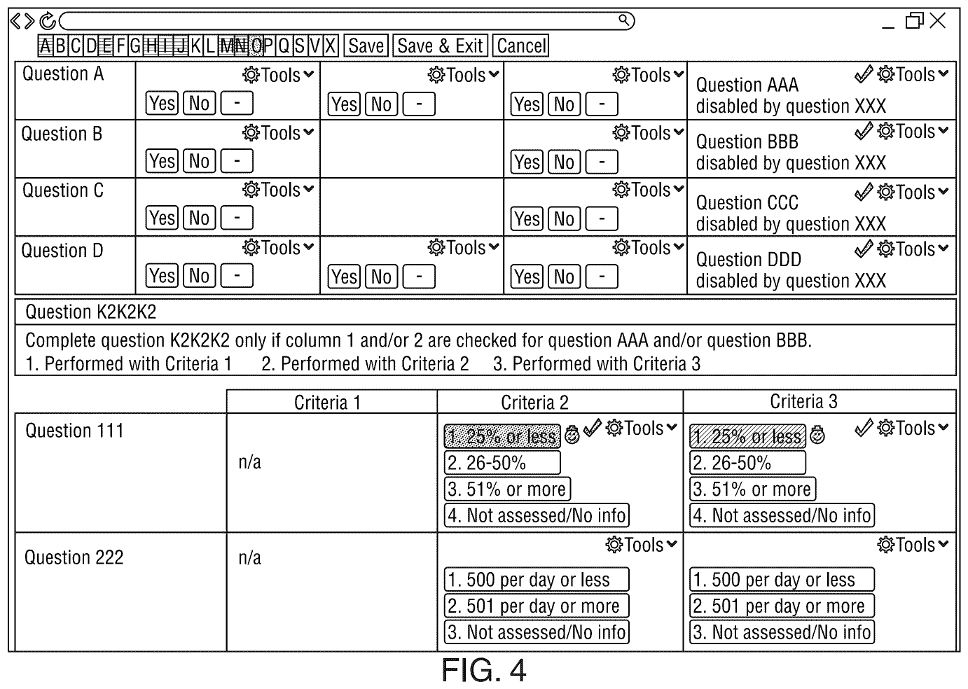

FIG. 4 shows an exemplary questionnaire. It should be noted that the color or other appearance of the checkmark and highlight may change in response to an operator approving the answer indicated by the application.

### Front-End-Displaying Sources on an Autofilled Document

The application may display the source that was the deciding factor behind the auto-generated answer for a specific question.
1. Auto-generated answers may be extracted from different sources. Sources may include previous forms, AI algorithms and/or external documentation. The sources may be stored in the database, such as the SQL server. The auto-generated answers may be sourced for each question in the questionnaire.
2. A response to a similar question (or the same question) on a previous document may be shown. Additional source information may be shown as well. Conflicts between the previous document and additional source information may be resolved by AI algorithms. Conflicts may be resolved by selecting a response that corresponds to a higher resource consumption metric.
3. Responses to similar questions, or the same question, on a previous document may be sourced, in certain embodiments, upon the click or selection of an application icon.
4. AI-generated answers may consider chart data and documentation. The chart data and/or documentation may be located within management software and/or retrieved from external sources. The answers may be sourced upon selection of the application icon. At times, the source may include text. As such, the text may be displayed. The portion of the text that is relevant to the answer may be highlighted, underlined or otherwise indicated to the operator. This may be the same text that is OCRed (optical character recognition), digitally entered and/or textually entered.
5. Answers that are retrieved from external documentation may be shown at the top of the form page. The displayed source may be a copy of the documentation, with each instance of the relevant text, indicated via highlight, underline or any other suitable indicator.
6. An operator may navigate from one relevant portion of a document to another relevant portion of the document. Each instance may be indicated. The documentation may provide navigation from one instance to another instance, from a first instance to a previous instance or a next instance, using an instance index or any other suitable navigation.
7. The source documentation may be created using software, such as Python's PDFPlumber library. External documentation may be in any suitable format, such as, for example, images, html files, pdf files, docx files or any other suitable file format.

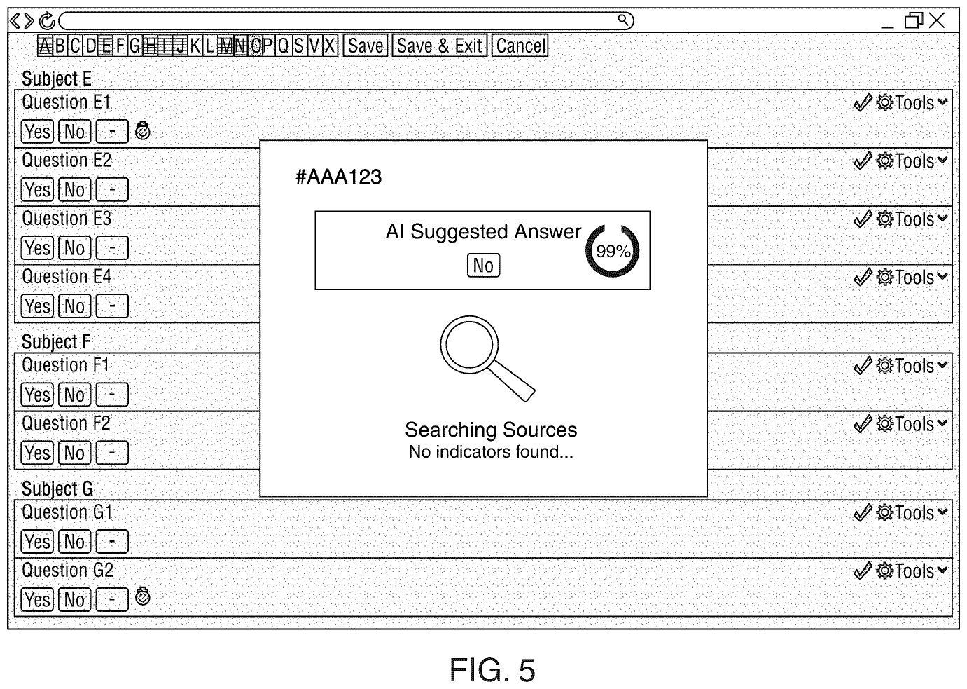

FIG. 5 shows displaying a source for an application-generated answer. As shown in FIG. 5, the AI-suggested answer may be negative. Additionally, as shown in FIG. 5, no sources may have been retrieved for this specific answer.

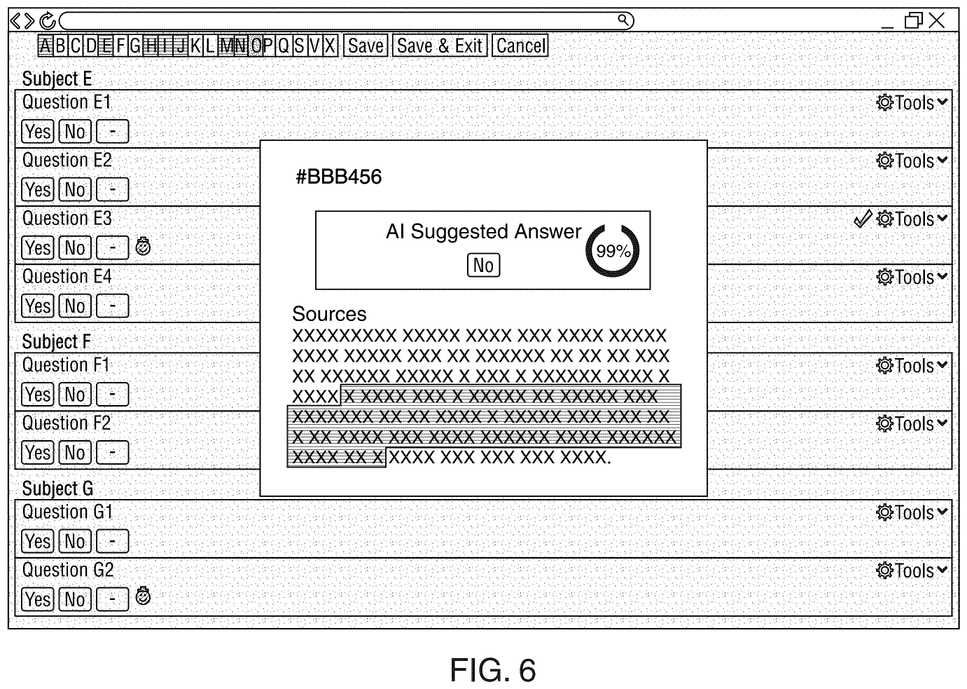

FIG. 6 shows displaying a source for an application-generated answer. As shown in FIG. 6, the AI-suggested answer may be negative. Additionally, as shown in FIG. 6, a source may be displayed. The portion of the source that is relevant to the question may be indicated to the operator. The indication may be highlighting of the text.

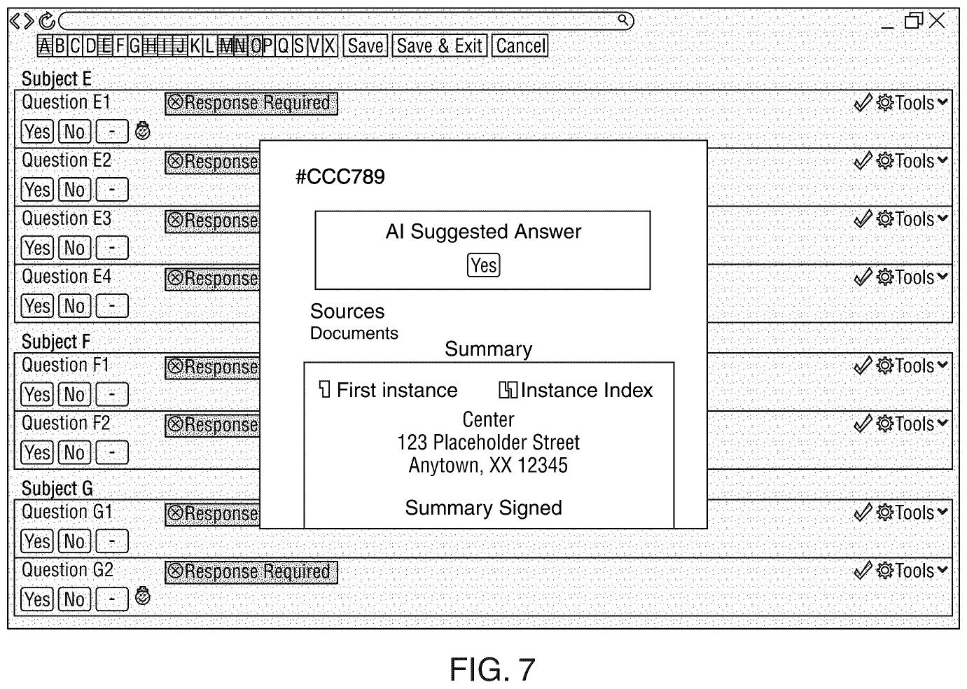

FIG. 7 shows displaying a source for an application-generated answer. The number of the question for which the answer is relevant may be shown as #CCC789. The AI-suggested answer may be yes. The displayed sources may include a document. The document may be a pdf document. The pdf document may be included in the pop-up that may appear when the application icon is selected. The document included within the pop-up may enable scrolling to relevant locations. The document may show links to relevant portions within the document. The links may be included as an overlay on the document itself, shown within the pop-up.

### Preprocessing Documents to be Used as Source Documents—Classifying Documents

The application may analyze a document, image or html files and classify it into a category. The categories may be selected from a set of preset categories. Examples of categories may be records, such as hospital records and/or therapy records, lab results, human resource records, telephone records and any other suitable categories. Documents containing data may be categorized into different categories. The following steps may be included in a data/text analysis.
1. An optical character recognition (“OCR”) processor may convert the document or image to text.
2. The text may be passed to a text vectorizer, such as TFIDF and to a gradient booster, such as an XGBoost model, in order to be classified. The classification may include a first type of classification and a second type of classification. In some embodiments, a higher recall may be assigned to the first type of classification in order that the first type of classification is not missed. As such, more resources may be pushed for documents classified as a first type of records in order not to miss any of the first type of records.
3. The text may then be passed into a TFIDF and XGBoost model with a higher precision for the first type of classification and may be assigned a secondary classification of the first type of classification or the second type of classification to ensure that the second type of classification is not missed.
4. The second layer of classification may be a Naive Bayes model that classifies the second type of classification documents into smaller groups based on their contents.
5. The second layer model may be re-trained with customized classification groups, which are set, or defined, by an operator. The operator may be a management operator.
6. In some embodiments, the documents may be categorized through both systems so that no documents are missed.

### Preprocessing Documents to be Used as Source Documents—Identify and Clean Markings on a Document

Once the documents have been identified and classified, the application may clean the documents to identify and remove markings and retain relevant data. The appropriate data may be extracted from the document. The appropriate data may be input to an AI model. It should be noted that the source document may be maintained in its original form. It should be further noted that the original form of the source document may be used to provide a source trail. The following steps illustrate identification of markings on source documents and retaining original documents.
1. A custom retrained computer vision model, such as a YOLOv8 model, may identify markings. Markings may include checkboxes, lines that may be checked off and/or encircled items. Markings may be identified on various documents such as PDF documents, html documents and images. It should be noted that source documents may include many permutations. The applicable permutations may be selected using a marking. For example, a person may select either condition A or condition B. At times, conditions A and B may be mutually exclusive. Other times, conditions A and B may be able to operate in tandem. As such, the markings may indicate which conditions are relevant in a specific embodiment.
2. The model may identify if the markable location, such as a checkbox, is marked or unmarked.
3. Empty or unmarked locations, in addition to surrounding text, may be replaced with white space. This may remove irrelevant information from the document.
4. OCR may be executed on the remaining portions of the document. Therefore, relevant information may initiate one of the OCR resources and irrelevant information may not initiate one of the OCR resources. The process may be designed to remove unnecessary information before executing the resource-intensive OCR task.

### Preprocessing Documents to be Used as Source Documents—Identifying Charts on a Source Document

A custom retrained computer vision model, such as a YOLOv8 model, may identify charts on files, such as PDF, html, image and any other suitable file. The model may send the document to the appropriate type of OCR processor. The selection of the OCR processor may be based on the classification. It should be noted that charts may be transmitted to a specific OCR processor. This OCR resource selection process may reduce computing resources associated with heavier OCR methods needed for chart data by correctly identifying document type and routing it to the correct OCR method.

### Preprocessing Documents to be Used as Source Documents—Classifying Areas on a Document

The application may use AI algorithms to organize documents. Organized documents are parsed using OCR processors with less resources than unorganized documents.
1. A custom retrained computer vision model, such as a YOLOv8 model, may identify blocks of text on a file, such as a PDF, html or image file. The model may rearrange the document to enable clear OCR with readable text.
2. A custom retrained computer vision model, such as a YOLOv8 model, may identify extraneous noises, such as logos and other such unnecessary images. The model may cover the garbage with white space. The extraneous noises-covering may be executed prior to the OCR so that the resulting text is clear.
3. It should be noted that, at times, documents may include two columns of text. The system may identify blocks of text, including forms, charts, columns and any other suitable blocks of text. The system may de-columnize the document so that the text lines up in a vertical manner. Additionally, headers may also be lined up in the right places. This may ensure that the OCR, which may be executed after the organization of the document, produces an accurate result.

### Preprocessing Documents to be Used as Source Documents—Identify Signatures on Documents

The application may identify signatures on documents. It should be noted that certain documents without signatures may be irrelevant and not be able to be used as source documents. As such, the application may identify, using a custom retrained YOLOv8 model, signatures on PDF, html, image or other suitable files. Documents without signatures may be removed from the computing workflow. This may reduce consumption of computing resources by using documentation supported by necessary signatures.

### Preprocessing Documents to be Used as Source Documents—Identify Tenses on a Document

At times, documents may include information relating to past, present and/or future. It should be noted that, at times, past information may be relevant, present information may be relevant and/or future information may be relevant. Also, at times, past information may be irrelevant, future information may be irrelevant and present information may be relevant. As such, a model may be used to identify relevant tenses and remove information that relates to other tenses.
1. The application may classify parts of a document as past, present or future. The application may extract present data, such as, for example, current status of an entity relating to the document, from the document.
2. Using OCR, text may be extracted from the document.
3. A text model, such as a LayoutLM model may be executed on the text. The text model may be used to classify each text statement as past, present or future.
4. Past and future text blocks may be removed. As such, a document may be produced that includes current data.
5. Removing unwanted tenses may improve the model's accuracy by removing unwanted text before leveraging AI processes that involve additional resources.
   Parsing Documents—Identifying Entities with Related Metadata on a Document

The application may identify entities and related metadata on a document using AI algorithms.

At times, documents may be annotated prior to being parsed by an AI model. For example, a manual annotation tool, such as UVI, may be used to instruct the AI model where an entity is located within the document. The manual annotation tool may be used to label one or more (or substantially all) instances of the entity. The manual annotation tool may also be used to instruct the AI model where related metadata, such as parameters, may be located within the document. After using the manual annotation tool to annotate one or more documents, the annotated documents may be input into the AI model. The AI model may parse additional un-annotated documents based on the training received from the annotated documents.

In one example, an entity may be a surgery. Metadata may be related to the entity. Related may also be referred to as parameters. Examples of parameters may include a date of the surgery, a name of the surgeon that performed the surgery, a type of the surgery and/or any other suitable parameters. In other examples, an entity may be an IV fluid instance and/or a feeding tube instance. As such, parameters of the entity may include dates associated with the IV fluid instances and dates associated with the feeding tube instances, dosage of the IV fluid instances and/or the feeding tube instances and/or any other suitable parameters.
1. LayoutLM token classification models (which may be retrieved from the Python Huggingface library) and SpaCy relationship models may be trained on annotated documents, where entities and related metadata are labeled.
2. A LongFormer model may be trained to classify pages from documents that include entities.
3. New documents may be passed through the LongFormer model.
4. The text from the documents may be extracted via OCR methods.
5. The text included in the pages classified by the LongFormer model may be fed through the LayoutLM model. The LayoutLM model may then identify the entities as well as the related metadata.
6. If the entities are identified in the text, the model may return the text snippet including the relevant information.
7. The text snippets including the entities and the related metadata may be passed into another model, such as a SpaCy relationship model. The SpaCy relationship model may assign each instance an accuracy score. The accuracy score may be based on relationships between the snippets.
8. Instances with an accuracy score above a chosen threshold and corresponding metadata may be highlighted on the documents. The documents, including the highlight, may be presented to the operator. A plurality of rules may be used to determine which documents and which highlights should be presented to the operator. It should be noted that the plurality of rules may be customizable. The plurality of rules may be customized when retraining the model.
   Parsing Documents—Extracting Dates from Documents

The application may identify dates on various documents, such as, for example, PDF, html and image files. Identifying which date on a document is specific to an event may be a complex task. Documents may use terms such as “three months ago” or “two weeks from now.” Documents may also include dates from facsimile transmissions or dates from email transmissions. Therefore, it may be useful to identify which date is appropriate for each entity identified within the documents.
1. The application may identify a date for an entity based on one or more of the following factors: a match between the entity and the date, location on date on page, proximity of date to entity and text surrounding date and date. The date information may be input into an AI model, which may determine a most appropriate date for an entity.
2. At times, the AI model may be fed with annotated documents in order to train the AI model. The text may be annotated within UBIAI to identify relevant and irrelevant dates. Irrelevant dates may include printed dates, facsimile dates, dates mentioned for scheduling purposes and any other irrelevant dates.
3. Using a LayoutLM model for token classification, relevant dates may be identified within the text. Relevant dates may be identified in various formats such as, for example, dd/mm/yyyy and month, day, year.
4. Using Python code and the dateutil library, dates may be converted to datetime objects. Datetime objects may be sorted in order that future dates may be removed, and the last date may be extracted.
5. A use case of the extracting dates method may include identifying if an operator used a piece of equipment within a specific date window in order to complete an assessment. Progress notes and assessment date may be retrieved and fed into the model. The model may return the dates found in the data in addition to instances of the piece of equipment (which may use the understanding text method). Using Python code and the dateutil library, dates may be converted to datetime objects so that future dates may be removed, and the last date may be extracted. The code may determine if the latest relevant date is within a predetermined time period, such as seven days.
   Parsing Documents—Extracting Codes from Documents

The application may identify codes from various documents, such as PDF, html or image files.
1. Test from documents may be extracted via OCR methods.
2. Using regex and Scikit-Learn model within Python, in addition to a TFIDF vectorizer, codes may be extracted based on predetermined text patterns. The patterns may match the codes.
3. Predetermined patterns may be customizable at the time of retraining the model.
4. Extracted codes may be highlighted, or otherwise indicated, within the documents.

A use case follows. At times, analysis, such as diagnosis, of an operator may be represented by a code within documentation. The code may be useful in completing an assessment of the operator. Thus, systems and methods according to the embodiments may simplify certain tasks.

### Understanding Text—Identifying User Characteristics in Management Software

The application may gather relevant data into one record in the management software and identify specific user characteristics.
1. Data from one record, including previous and current assessments, notes and chart data may be retrieved. One record may relate to one user. One record may relate to a plurality of users.
2. XGBoost, an AI model, may be used to predict if a user characteristic is identified. The model may, using a high recall, serve as a filter overpredict in order not to miss any potential characteristics.
3. The results of the above may be used to create a smaller subset. The subset may be for a BERT model. The BERT model may identify the source that provides evidence that the user characteristic has been identified.
4. The user data may be used to identify a source such as a chart, an assessment, notes and longer forms of text, such as, for example, text extracted from PDFs, html files and images.
5. The potential user characteristic, identified from the XGBoost results, may have a source in the resulting BERT dataset. In such an embodiment, the application may confirm that the answer is accurate over a predetermined threshold.

In some embodiments, the process may be understood as follows: data may be retrieved from various sources. In the process, the various source documents may be manipulated, annotated, stripped or otherwise changed. The retrieved data may be input in an XGBoost model. The XGBoost model may identify answers, based on the retrieved data and/or other information, to questions within the document. When the answers are negative, the process may terminate. When the answers are positive, the answers may utilize a source document. Positive answers may be referred to as non-default answers. As such, the data used to identify the positive document may be fed, data element by data element into a second AI model. The second AI model may identify untouched source documents used to identify the answer. The second AI model may pass the untouched source documents to the front end. The front end may annotate, such as by highlighting, the annotated source documents to be shown to an operator.

### Understanding Text—Identify Events in Text

The application may identify actual events as opposed to a negated event. If an event is associated with a negation, the instance of the event is dropped. The list of events may be pre-generated or preloaded.

The application may use a model when a standard BERT model does not perform appropriately. As discussed above, annotated text may be used to retrain a BERT model to identify events.
1. Using the tool, words related to an event may be annotated and assigned an event label.
2. Another entity label may be created for words that negate an event. Such words may include NOT. As such, the model may be able to learn the difference between an event that occurred and an event that did not occur even though the same event word may be present.
3. Relationships may be created between event instances and negated event instances.
4. To use this model for predictions, text may be fed into the model and the model may return substantially all of the entities and their relationships. Using Python, the application may check if entities have a relationship, in which case those instances may be dropped. The remaining instances may be saved together with the accompanying source text.

This method may be used to identify patient instances, such as, for example, instances of a resident vomiting identified from progress notes and assessments within the software.

### Understanding Text—Identify Event Duration on Documents

The application may identify if an event occurred and the length of the event—i.e., how long the event lasted.
1. Text may be parsed from documents, such as, for example, PDFs using OCR methods.
2. Using Regex and Python, the application may identify if an event is present on a document.
3. If an event is present on a document, the application may capture and calculate the minutes of occurrence that took place on each day during the document.
4. The application may return the total minutes of the event for a specific day.

The method may, for example, be used to identify IV fluids and/or respiratory assistance administered to a resident for a specific number of minutes in a day.

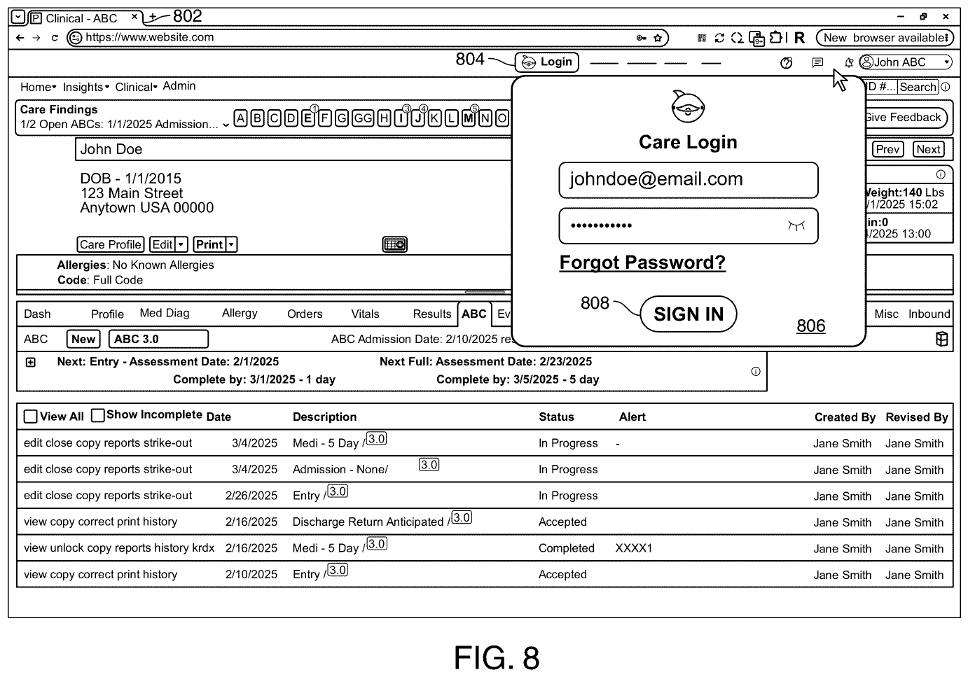

FIG. 8 shows an illustrative diagram. An operator may have been authenticated to access the browser-based application open in browser 802. The operator may access the browser-based application on behalf of a second user—e.g., the subject. The second user may be a resident of a facility, such as, for example, a nursing facility. The operator may be an employee of the facility.

The browser-based application may display an interactive document. The interactive document, may in certain embodiments, be an assessment. The assessment may include questions to be completed by the operator. The assessment may be provided to a third party, such as for example, an insurance company. The assessment may provide details to the third party regarding the care of the second user within the facility. The provided details may be used by the third party to determine resource consumption of the second user within the facility.

The operator may also access a browser extension application. Access to the browser extension application may be initiated by selecting login button 804. Upon selecting login button 804, the operator may be prompted to enter authentication credentials into popup sign in window 806. Upon entry of correct authentication credentials, including username and password and selection of the sign in selectable button 808, the operator may be authenticated by the browser extension application.

Upon authentication of the operator by the browser extension application, the underlying application operating within the browser may be overlayed with data provided by the browser extension application. As such, additional information, selectable buttons and other suitable data may be displayed to the operator on the application operating within the browser.

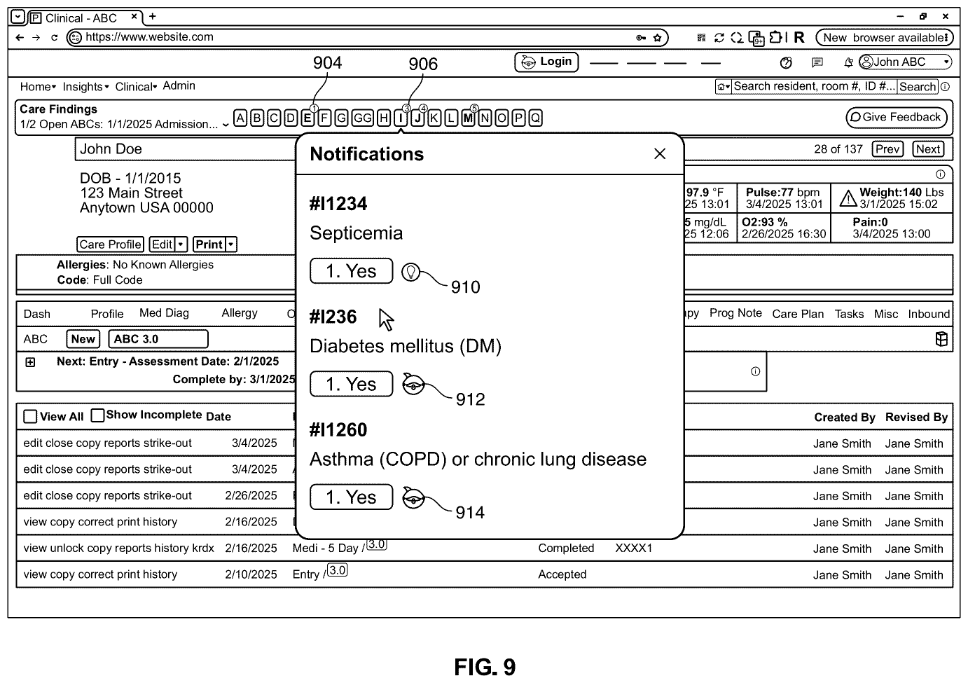

FIG. 9 shows another illustrative diagram. Upon authentication of the operator by the browser extension application, overlay 902 may be displayed. Overlay 902 may include additional information provided by the browser extension application to assist the operator in completing the interactive document. Overlay 902 may display findings to the operator. The findings may show that one out of two interactive documents/assessments assigned to the second user are currently open. As such, the operator may be able to complete or provide more information within the interactive document/assessment.

Overlay 902 may also include icons that indicate alphanumerical notifications. It should be noted that an interactive document/assessment may include a plurality of sections. One or more sections within the interactive document/assessment may require completion prior to the interactive document/assessment being labeled complete. Each section may be assigned an alphanumerical tag. As such, tag A may correspond to section, tag B may correspond to section B, etc. Each tag may be selectable. As such, when an operator selects tag A, the operator may be directed to section A within the interactive document/assessment.

Overlay 902 may also include a notification tag on top of, or adjacent to, the section tag. For example, notification tag, shown at 904, may be on top of, or adjacent to, section tag E. The notification tag may include an indicator. The indicator may be a numerical indicator. The numerical indicator may indicate a number of fillable options, or questions, that may be completable within the section. As such, notification tag 904 may indicate that one question may require completion within section E. Notification tag 906 may indicate that three fillable options, or questions, may require completion within section I.

When the operator hovers over, or selects, a notification tag, such as, for example notification tag 904 or notification tag 906, a pop-up window may be opened. The pop-up window may display to the operator the fillable options, or questions, within the section that require completion. Pop-up window 908 may display to the operator the three fillable options, or questions, that require completion. For each of the three fillable options, pop-up window 908 may display a suggested answer. The suggested answer may be based on data retrieved from various source documents. The suggested answer may be assigned by an AI engine. The AI engine may be electronically linked to the browser extension application. The AI engine may be electronically linked to a database. The database may store the source documents.

An icon may be displayed adjacent to the suggested answer. The icon may be selectable. The icon may indicate a level of confidence that the AI engine, linked to the browser extension application, assigned to the suggested answer.

In some embodiments, there may be multiple ranges of levels of confidence. As such, the icon may indicate a range of a level of confidence. For example, icon 910 may indicate that the AI engine has less than a threshold level of confidence that the suggested answer yes is the correct answer to the first displayed question. At times, the level of confidence may be determined by multiple factors. The multiple factors may include a number of times the answer was found in the source documents. For example, at times, if a term, corresponding to the question, was found in the source documents less than three, or any other suitable number of, times, the suggested answer may be assigned less than a predetermined level of confidence. In other example, if a term, corresponding to the question, was found in the source documents more than three, or any other suitable number of, times, the suggested answer may be assigned greater than a predetermined level of confidence.

In certain embodiments, a third icon may be displayed. The third icon may indicate that proof was located for the suggested answer, however, the fillable option may not be completed with a formal assessment.

Icon 912 may indicate that the AI engine assigned greater than a threshold level of confidence to the answer yes for the associated question. Icon 914 may indicate that the AI engine assigned greater than a threshold level of confidence to the answer yes for the associated question. Icons 910, 912 and 914 may each be selectable icons. Upon selection of icons 910, 912 or 914, a pop-up window may be instantiated.

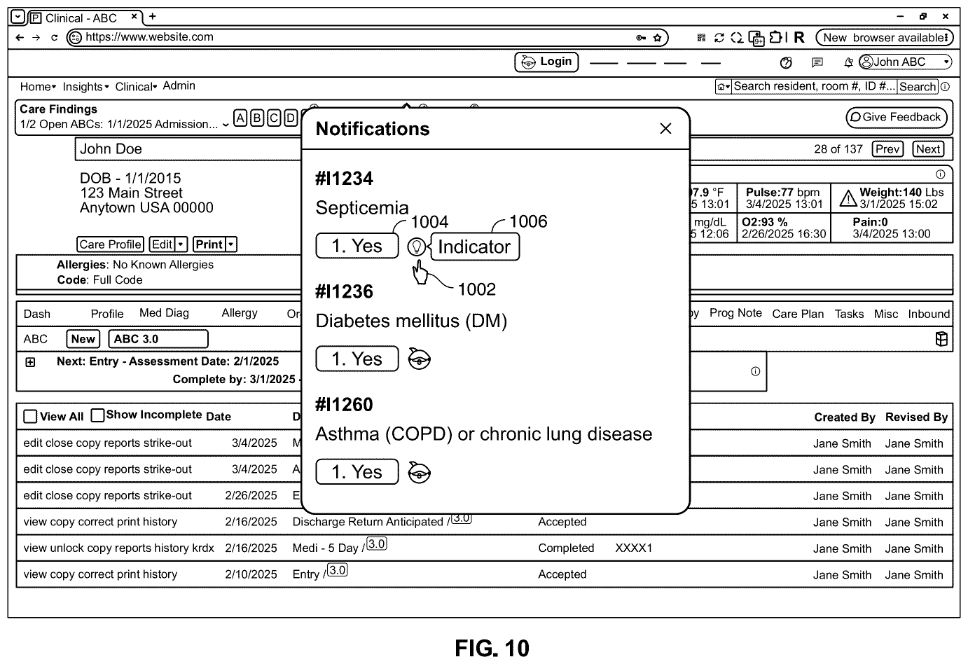

FIG. 10 shows an illustrative diagram. Pointer 1002 may hover over icon 1004. When pointer 1002 hovers over icon 1004, icon 1004 may display textual indicator 1006. Textual indicator 1006 may show that icon 1004 is an indication of additional data relating to the associated question. It should also be noted that icon 1004 and/or textual indicator 1006 may be selectable. Upon selection of icon 1004 and/or textual indicator 1006, a pop-up window may be instantiated.

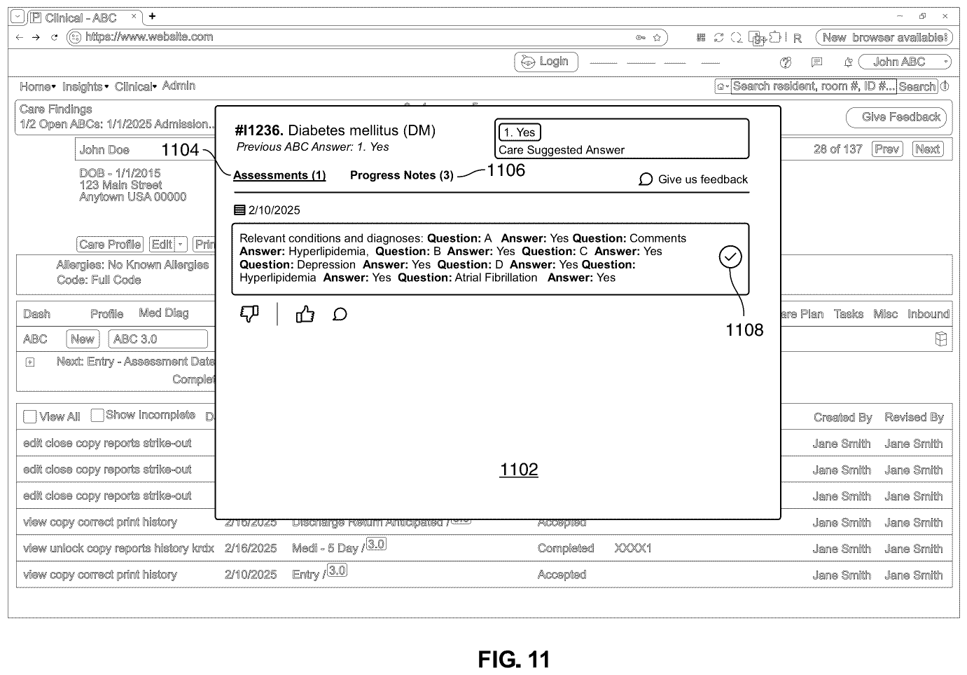

FIG. 11 shows an illustrative diagram. The illustrative diagram shows pop-up window 1102 instantiated in response to selection of an icon, such as, for example, icon 912 shown in FIG. 9. Pop-up window 1102 may include data relating to how the AI engine suggested the yes answer. Pop-up window 1102 may include data relating to the question, such as, for example, the question number and/or data relating to the question. Pop-up window 1102 may include data related to the question and to the subject, such as, for example, previous answers to the same or similar questions provided in one or more other interactive documents associated with the subject, stored documents related to the subject, other interactive documents related to the subject, summaries of other interactive documents related to the subject, notes and/or feedback entered by one or more operators related to the subject and any other suitable data.

Pop-up window 1102 may include tabs, shown at 1104 and 1106. Each of tabs 1104 and 1106 may display source documents. When selected, tab 1104 may display an assessment. The numerical indicator displayed within tab 1104 (1) may indicate that there is one available assessment. The numerical indicator displayed within tab 1106 (3) may indicate that there are three available progress notes.

In some embodiments, the numerical indicator displayed within tab 1104 (1) may indicate that there is one instance of an answer to the question displayed within pop-up window 1102. In certain embodiments, the numerical indicator displayed within tab 1106 (3) may indicate that there are three instances of an answer to the question within pop-up window 1102.

Pop-up window 1102 may also include selectable indicator 1108. Selectable indicator 1108 may enable the operator to select the source displayed within pop-up window 1102. Selection of selectable indicator 1108 may provide an indication that the operator selecting selectable indicator 1108 agrees and/or approves of the source displayed within pop-up window 1102. Upon selection of selectable indicator 1108, selectable indicator 1108 may change a visual display, such as, for example, including a colored background. At times, upon selection of selectable indicator 1108, may change a visual display of the source displayed within pop-up window 1102. It should be noted that the changed visual display may be visible by another operator, such as, for example, another facility employee, viewing the interactive document/assessment displayed within the browser.

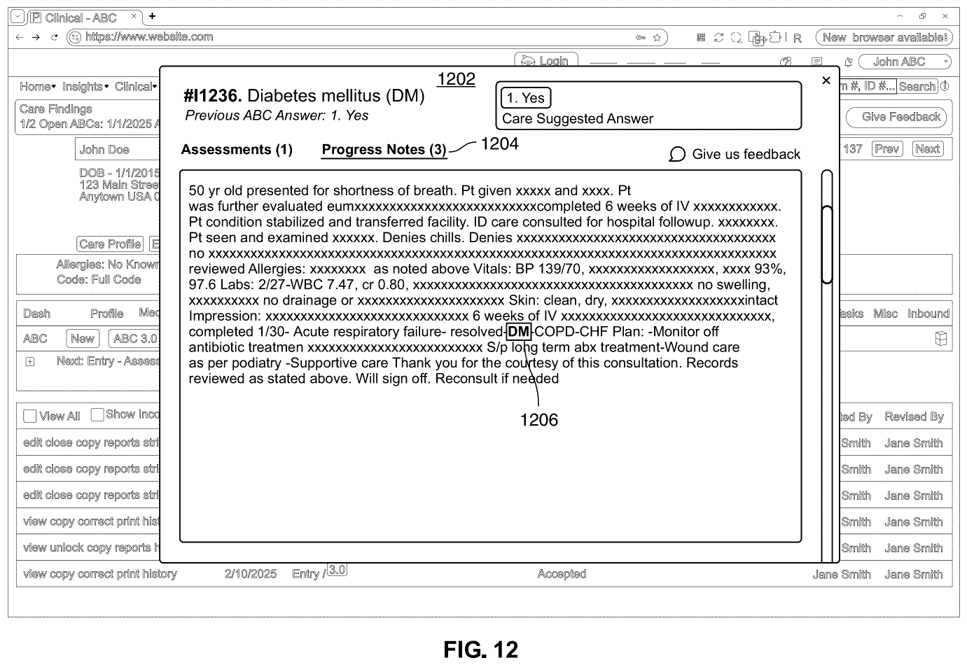

FIG. 12 shows an illustrative diagram. The illustrative diagram shows pop-up window 1202 instantiated in response to selection of an icon, such as, for example, icon 912 shown in FIG. 9. An operator may have selected tab 1204. Upon selection of tab 1204, pop-up window may display the progress notes. The progress notes may include textual indication 1206 of the question displayed within pop-up window 1202. Textual indication 1206 may include highlight, italicized, underline, square, box or other suitable textual indication of one or more text components to show the operator where the AI engine identified an answer to the question displayed in pop-up window 1202.

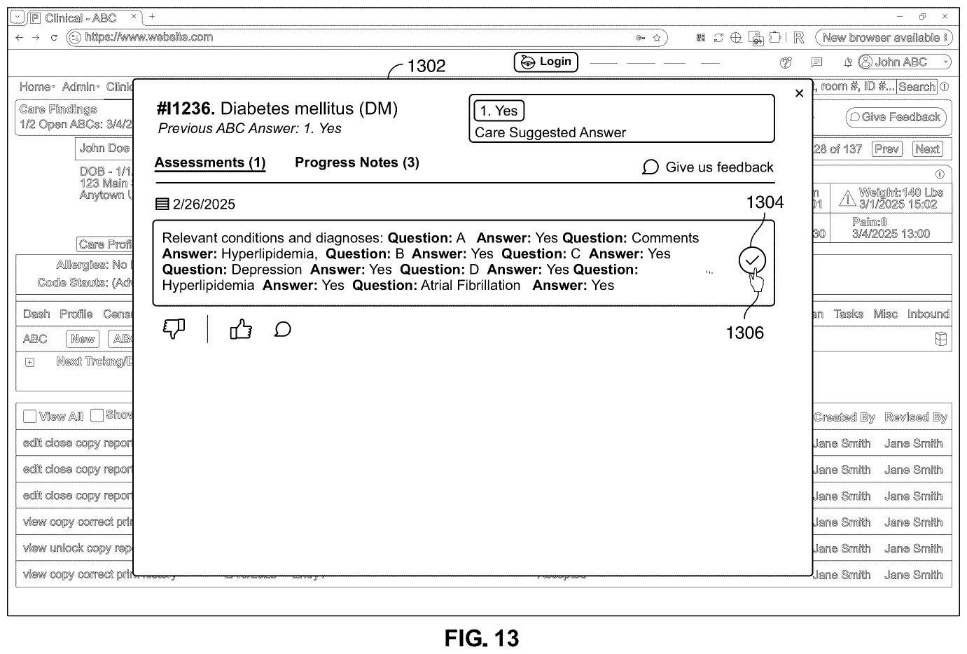

FIG. 13 shows an illustrative diagram. The illustrative diagram shows pop-up window 1302. Pointer 1306 may be shown selecting selectable icon 1304. Selectable icon 1304 may be similar to selectable icon 1108 shown in FIG. 11.

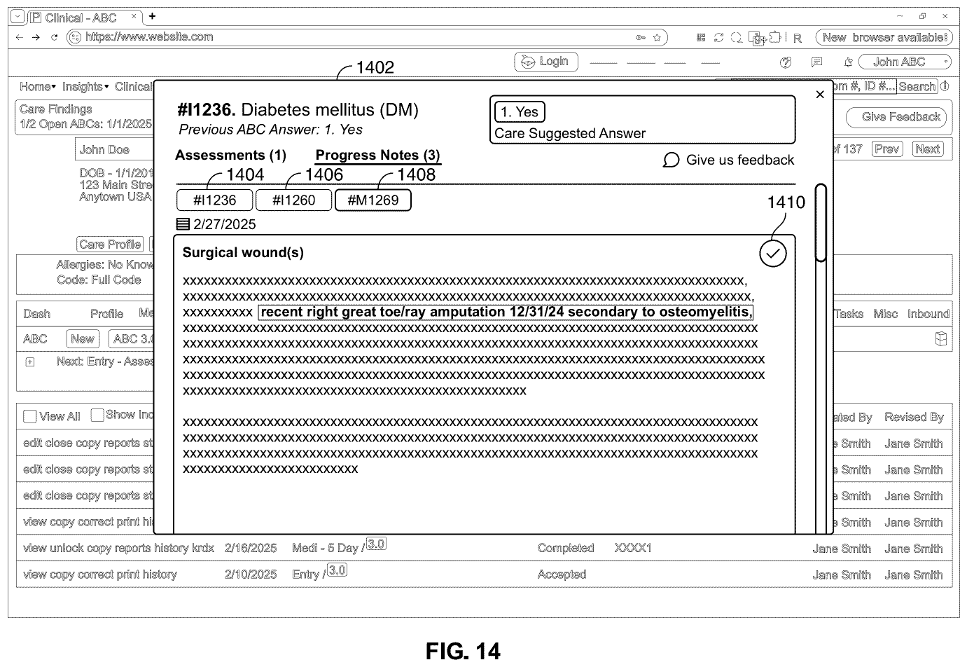

FIG. 14 shows an illustrative diagram. The illustrative diagram shows pop-up window 1402. Pop-up window 1402 may be open to a progress notes tab. It should be noted that the operator may have opened pop-up window 1402 using a first question, which is shown at the top of pop-up window 1402. Pop-up window 1402 may display the progress notes within pop-up window 1402. It should be noted that textual indication 1412 may indicate to the operator one or more text components to display to the operator where, within the source document, the AI engine identified an answer to the question displayed in pop-up window.

Pop-up window 1402 may also display a plurality of question numbers. The question numbers may include the current question number, shown at 1404, a second question number, shown at 1406 and a third question number, shown at 1408. The browser extension application may have displayed one or more additional question numbers, shown at 1406 and 1408 to indicate to the operator that the source document, such as the progress notes and/or the textual indication 1412 may be relevant to, and/or provide a basis for an answer the AI engine autofilled, the additional questions numbers.

Furthermore, the additional question numbers may be selectable. As such, the operator may be able to select the question numbers to approve or complete the questions upon completion of the current question. Toggling between multiple questions for which the autofilled information may be sourced from the same source document may assist the operator because once the user has reviewed the displayed source document, the operator may be able to effectively and efficiently approve autofilled answers to the other question numbers.

Selectable indicator 1410 may be similar to selectable indicator 1108 shown in FIG. 11. Additionally, selectable indicator 1410 may be selected for each of questions 1404, 1406 and 1408. At times, selecting selectable indicator 1410 for a first question—e.g., when the first question is displayed and a corresponding source document is displayed—may modify the display of the same source document for a second question, such as for example, when question labeled 1406 is displayed. This may indicate to the operator that the source document has been approved by the user (or another user, for example, another facility user).

In certain embodiments, selecting selectable indicator 1410 for a first question—e.g., when the first question is displayed, a corresponding source document is displayed and a corresponding textual indicator is shown—may modify the display of the same source document and corresponding textual indicator is displayed for a second question, such as, for example, when question labeled 1406 is displayed. This may indicate to the operator that the source document including the corresponding textual indicator has been approved by the operator (or another user, for example, another facility user).

In some embodiments, selecting selectable indicator 1410 for a first question may not change—i.e., maintain an original view of—the display of the source document when displayed for a second question.

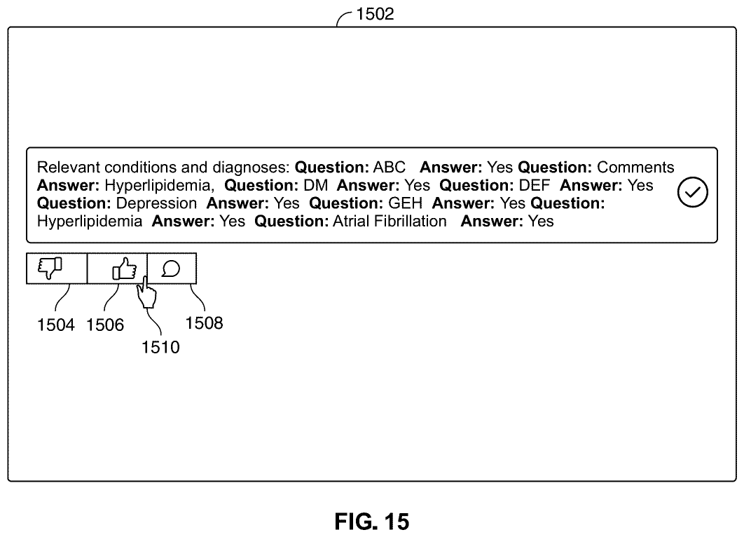

FIG. 15 shows an illustrative diagram. The illustrative diagram shows section 1502 of a pop-up window. The pop-up window displayed may be similar to pop-up window 1302 displayed in FIG. 13. Pointer 1510 may be shown selecting thumbs-up icon 1506. Upon selection of thumbs-up icon 1506, an operator may indicate approval of the source document provided to the question displayed within section 1502. The thumbs-up selection/approval of the source document may be displayed to other users, such as, for example, other facility employees. In certain embodiments, the thumbs-up/approval may be displayed to the other users when the other users utilize the browser extension application and open the same source document. Other times, the thumbs-up selection/approval of the source document may be displayed to other users in a list data structure or other suitable data structure or format. The thumbs-up selection/approval may enable facility employees of a facility to electronically communicate with one another.

At times, an operator may select thumbs-down icon 1504. Thumbs-down icon 1504 may indicate lack of approval, or failure to approve the source document displayed within section 1502. The thumbs-down selection/lack of approval of the source document may be displayed to other users, such as, for example, other facility employees. The thumbs-down/lack of approval of the source document may be displayed to other users when the other users utilize the browser extension application and open the same source document. The thumbs-down/lack of approval of the source document may be displayed to other users in a list data structure or any other suitable data structure or format. The thumbs-down selection/lack of approval may enable facility employees of a facility to electronically communicate with one another.

The operator may also be able to select chat bubble selectable icon 1508. Chat bubble selectable icon 1508 may enable the operator to type information or messages regarding the source document. The information or messages may be displayed to other users, such as, for example, other facility employees, when the other users utilize the browser extension application and open the source document. The information or messages may be displayed to the other users in a list data structure or any other suitable format.

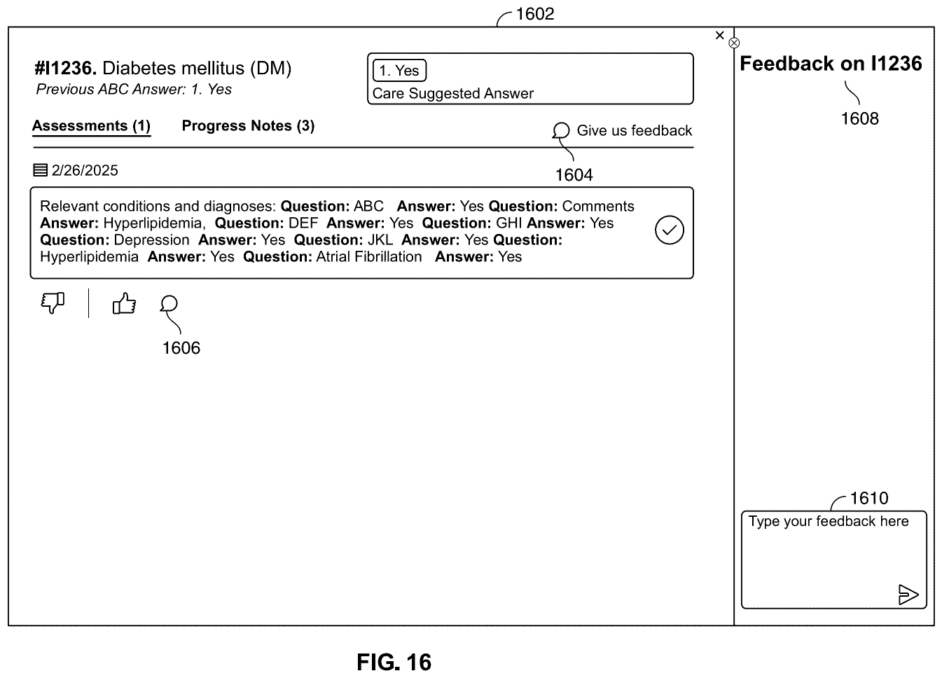

FIG. 16 shows an illustrative diagram. The illustrative diagram shows pop-up window 1602. Pop-up window 1602 may be similar to pop-up window 1102. Pop-up window 1602 may include chat bubble selectable icon 1606. Chat bubble selectable icon 1606 may be similar to chat bubble selectable icon 1508. Pop-up window 1602 may include chat bubble selectable icon 1604. Upon selection of chat bubble selectable icon 1604 and/or upon selection of chat bubble selectable icon 1606, feedback column 1608 may be instantiated. Feedback column 1608 may include feedback, information and/or data provided by one or more operators. The feedback, information and/or data may include thumbs-up icons and thumbs-down icons provided by one or more operators. The feedback, information and/or data provided by the one or more operators may be tagged with names of the operators that provided the feedback, information and/or data. An operator may be able to provide textual feedback by entering textual data into feedback entry box 1610.

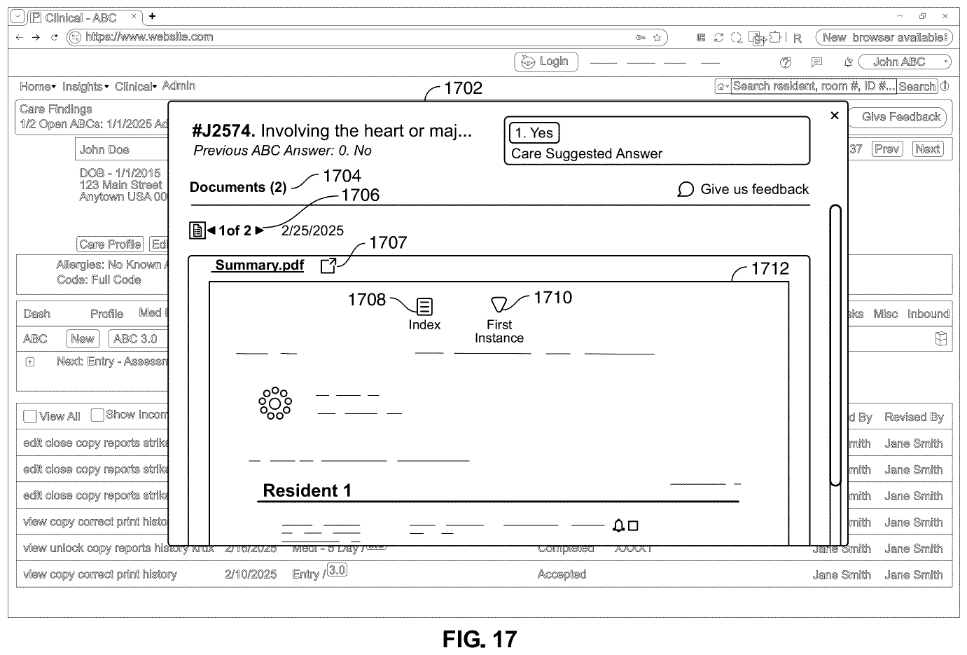

FIG. 17 shows an illustrative diagram. The illustrative diagram shows pop-up window 1702. Pop-up window 1702 displays a question. Pop-up window 1702 may have been instantiated in response to selection of an icon adjacent to the question within the interactive document. Pop-up window 1702 may include tab 1704. Tab 1704 may be a documents tab. Documents tab 1704 may include a tab indicator within documents tab 1704. The tab indicator may indicate that there may be two (2) documents to be displayed. Selectable icon 1706 may enable an operator to toggle between displaying a first document and a second document.

First source document 1712 may be displayed within pop-up window 1702. First source document 1712 may have been selected because source document 1712 may display one or more instances of a reasoning for a yes answer provided by the AI engine for the displayed question. It should be noted that the source document may be annotated by the browser extension application. The annotations may include textual annotations, such as highlights, underlines, circles, squares or any other suitable annotations. The annotations may annotate textual information within source document 1712. The annotated textual information may show text within source document 1712 that corresponds to the instances of the reasoning for the yes answer provided by the AI engine.

The annotations may include an initial source document bar. The initial source document bar may be displayed prior to an operator perusing source document 1712. The initial source document bar may include index selectable button 1708 and first instance source document selectable button 1710. Index selectable button 1708 may instantiate an index of source document 1712. The index of source document 1712 may include location information, within source document 1712, of each instance, of the reasoning for the answer provided by the AI engine. When selected, first instance of source document selectable button 1710 may electronically reposition source document 1712 to the first instance of the reasoning for the answer provided by the AI engine.

When selected, selectable icon 1707 may instantiate another pop-up window in which the operator can view source document 1712 without other information—i.e., in an isolated environment.

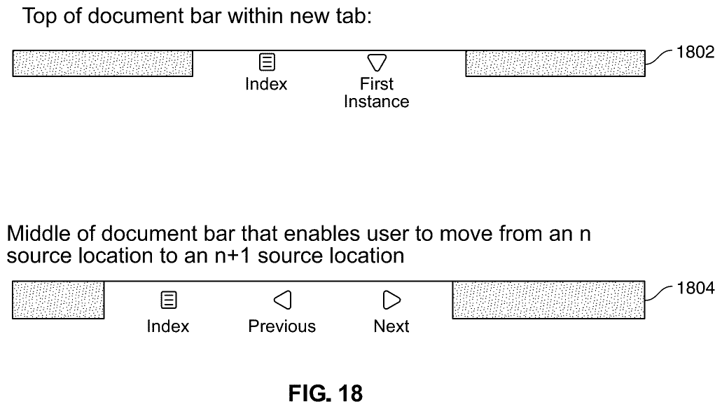

FIG. 18 shows an illustrative diagram. The illustrative diagram shows initial source document bar 1802 and intermediary source document bar 1804. Initial source document bar 1802 may be displayed prior to an operator perusing a source document. Initial source document bar 1802 may include an index selectable button and a first instance selectable button. Intermediary source document bar 1804 may be displayed within a source document upon a repositioning of the source document—i.e., after the operator has begun perusing the source document. Intermediary source document bar 1804 may enable an operator to move or auto-reposition the document from a first (n) source location within the source document to a second (n+1) source location within the source document.

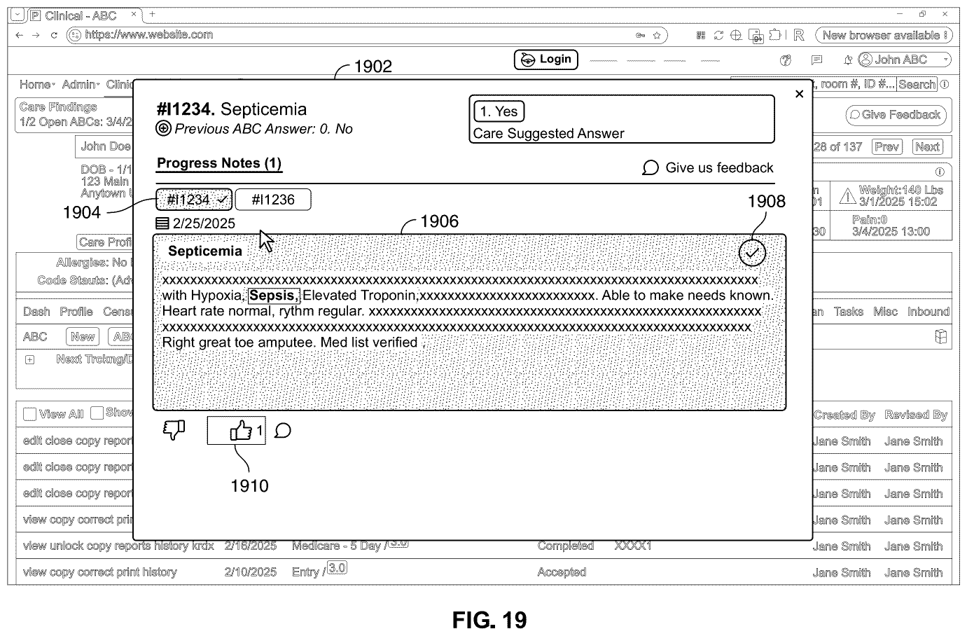

FIG. 19 shows an illustrative diagram. The illustrative diagram shows pop-up window 1902. Upon selection of selectable indicator 1908, the background of source 1906 and associated question number 1904 may be shown with a textual indication of approval. In some embodiments, the textual indication of approval may include a change in a coloring of the background of question number 1904 and/or source 1906, which may be a progress note. Additionally, it should be noted that the progress note may have received a thumbs-up indication from an operator, as shown at 1910.

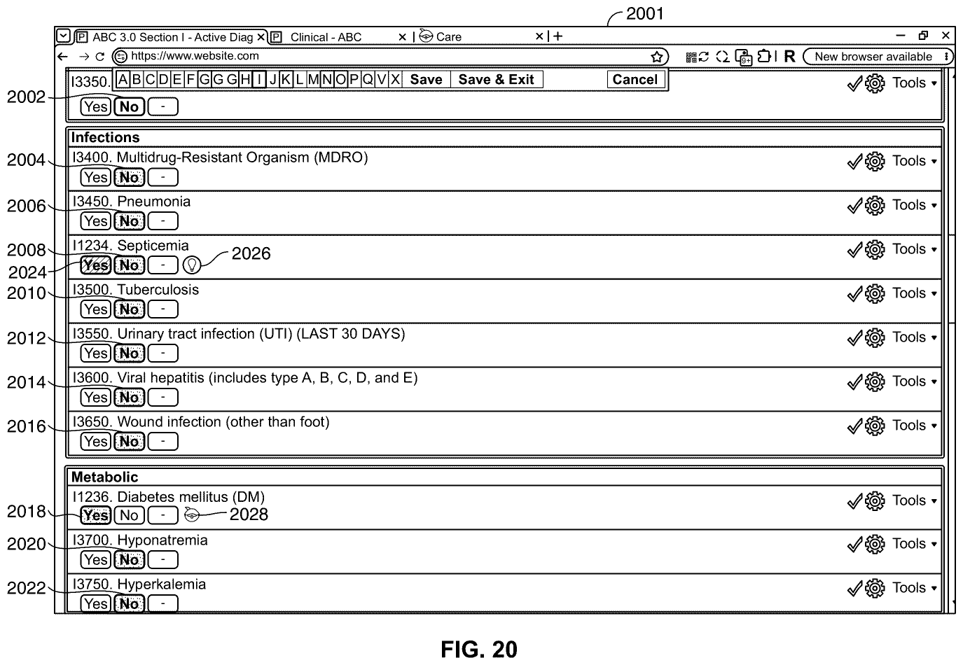

FIG. 20 shows an illustrative diagram. The illustrative diagram shows an interactive document displayed within browser 2001. The interactive document may include a plurality of selectable options. Each of the selectable options shown within browser 2001 may include a selectable yes option, a selectable no option and a selectable not relevant option (displayed as a dash). Each selected option may be shown with a first background, as shown at options 2002, 2004, 2006, 2008, 2010, 2012, 2014, 2016, 2018, 2020 and 2020. Each selected option may have been selected by an operator. Each selected option may have been selected by a first automated process.

The browser extension application may recognize the selection of each of selectable option. The browser extension application may recognize, using an artificial intelligent engine, that the selected option should be different from the option selected by an operator or the first automated process. As such, the browser extension application may generate an indication to the operator to change the selected option. The indication may be a change in a background of the option to be selected. The AI engine may indicate that option 2024 may be more accurate than option 2008. Therefore, the browser extension application may display a change in the background of option 2024. Additionally, the browser extension application may display indicator 2026. Indicator 2026, when selected, may display a source document or more information, to the operator regarding the recommendation for the change in the selected option. The source document other information may be displayed to the operator via a pop-up window or other suitable information display. The background of option 2024 may also change upon selection and/or verification of the selected option by the operator.

It should be noted that the operator may also select a checkmark, such as checkmark 2030, to indicate the approval of the selected option. Upon selection of either the selectable option and/or the checkmark, a visual indicator, such as, for example, a background color, of the selectable option and/or the checkmark may change. It should also be noted that, at times, the operator may be required to click on either the checkmark or the selectable option to indicate approval and in order for the interactive document to be considered complete.

The browser extension application may also display an indicator, such as indicator 2028 adjacent to a question for which the browser extension application has located a source document. Selecting indicator 2028 may display a source document, or other information to the operator. The source document or other information may be displayed to the operator via a pop-up window or other suitable information display.

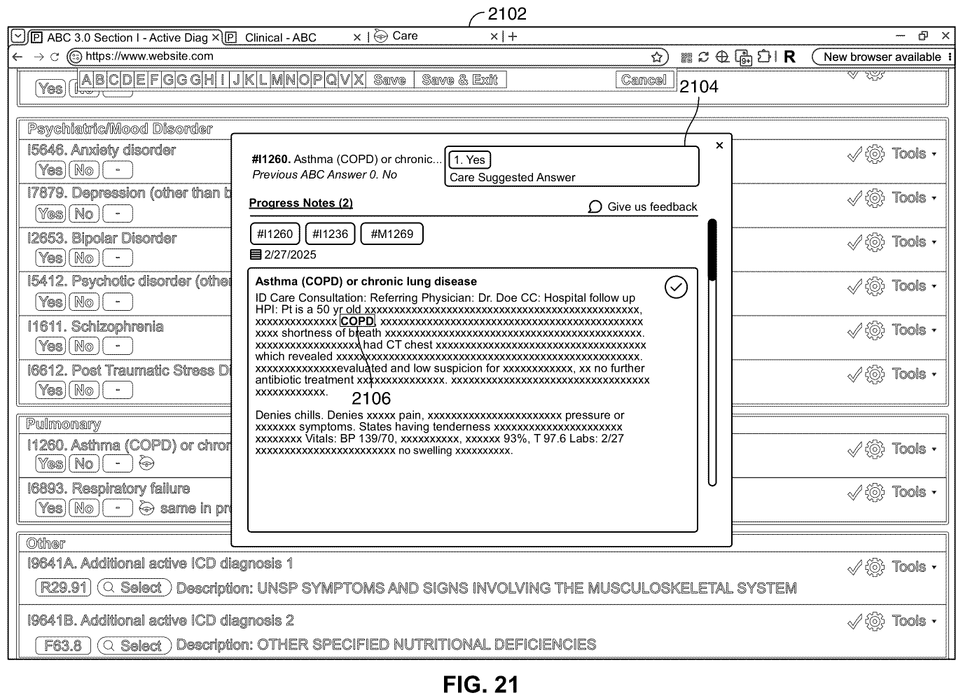

FIG. 21 shows an illustrative diagram. The illustrative diagram shows display of pop-up window 2104 on top of browser 2102.

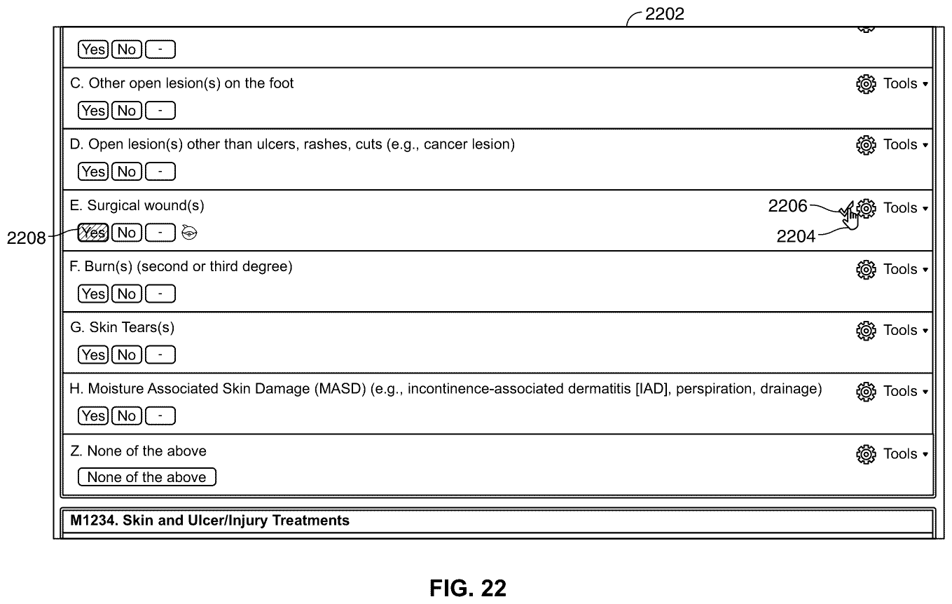

FIG. 22 shows an illustrative diagram. The illustrative diagram shows an interactive document displayed within browser 2202. Pointer 2204 may be selecting checkmark 2206. Selection of checkmark 2206 may indicate the operator approval of the selection of selectable option 2208.

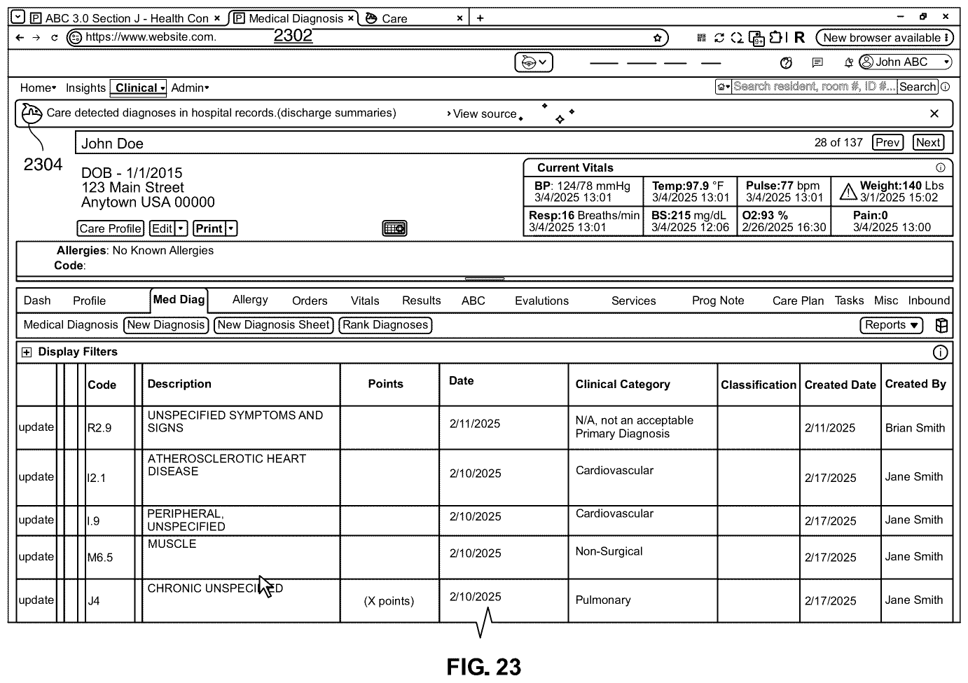

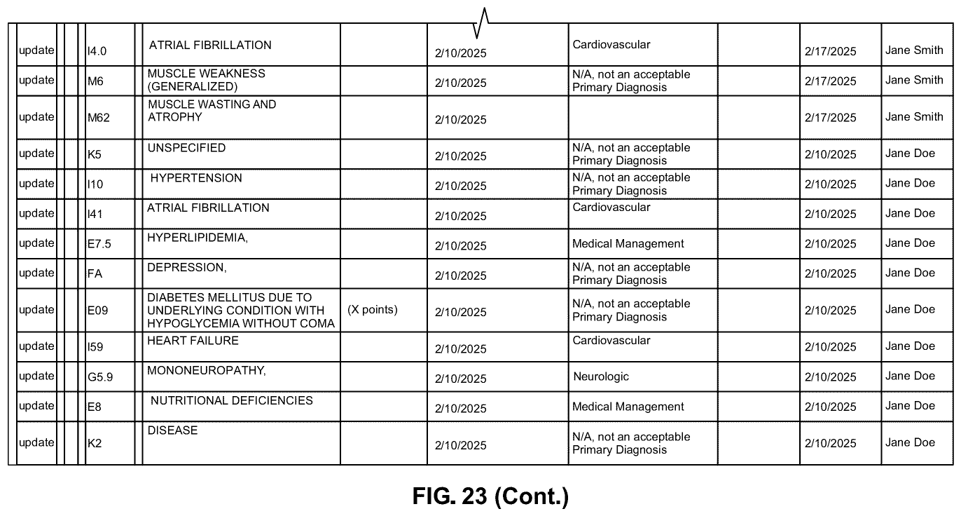

FIG. 23 shows an illustrative diagram. The illustrative diagram shows an interactive document displayed within browser 2302. The interactive document may include diagnoses and associated diagnosis codes associated with a subject, such as, for example, a resident of a skilled nursing facility. An artificial intelligence engine may display an indicator bar, shown at 2304, that additional diagnosis codes may be available in other source documents. Indicator bar 2304 may be selectable and/or include one or more selectable options.

At times, an AI engine may scan each record, such as, for example, a discharge record summary and retrieve diagnoses from the scanned records. Each diagnosis may be classified, for example, as (1) a primary hospital diagnosis, (2) a significant diagnosis, which may be the basis for residing in a skilled nursing facility and/or as (3) another diagnosis. The diagnosis may be displayed in an interface. The diagnosis may be linked to the associated source document.

Additionally, a specific category scanner may scan a record to identify and label diagnosis that can be used to complete fillable or open-ended options for a specific category, such as, for example, a non-therapy ancillary category. The specific category scanner may also identify and label diagnosis that may receive positive category points on an interactive documents.

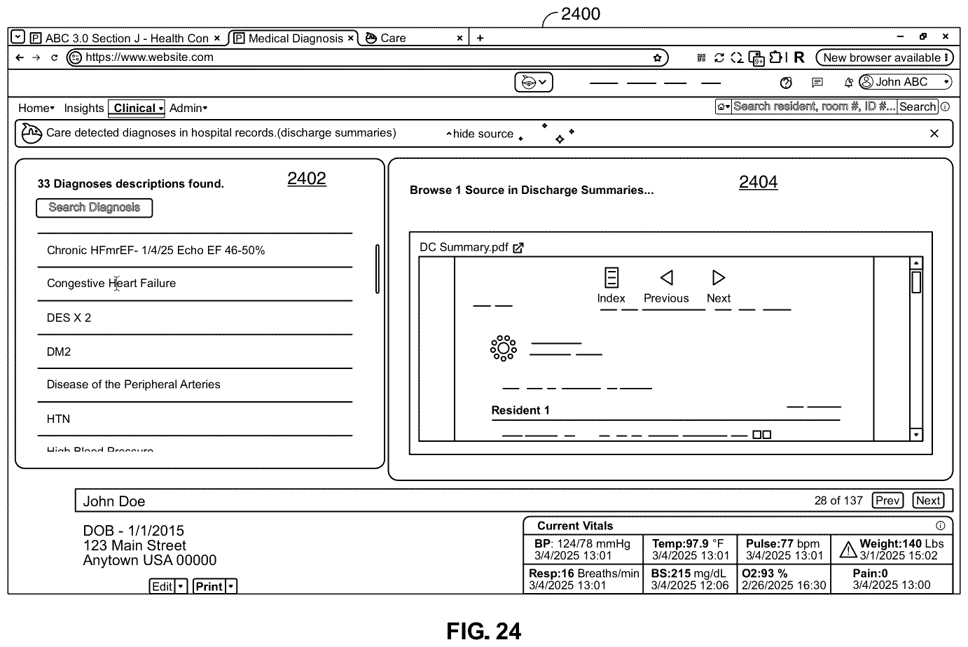

FIG. 24 shows an illustrative diagram. Upon selection of indicator bar 2304 in FIG. 23, the browser extension application may instantiate browser 2400. Browser 2400 may display source document display window 2404. Source document display window 2404 may display to an operator a source document showing the additional diagnosis codes. The source document bar may enable the operator + to autoreposition the document to the locations within the source document that indicate an additional diagnosis code. Additionally, diagnosis descriptions may be retrieved from the document and displayed within window 2402.

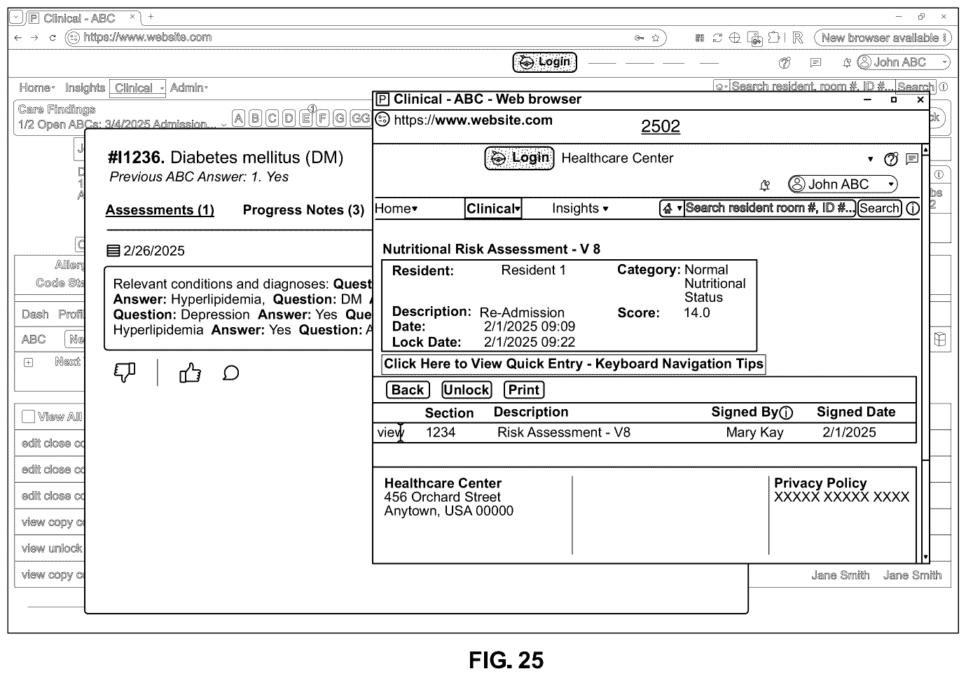

FIG. 25 shows an illustrative diagram. The illustrative diagram shows an exemplary interactive document 2502.

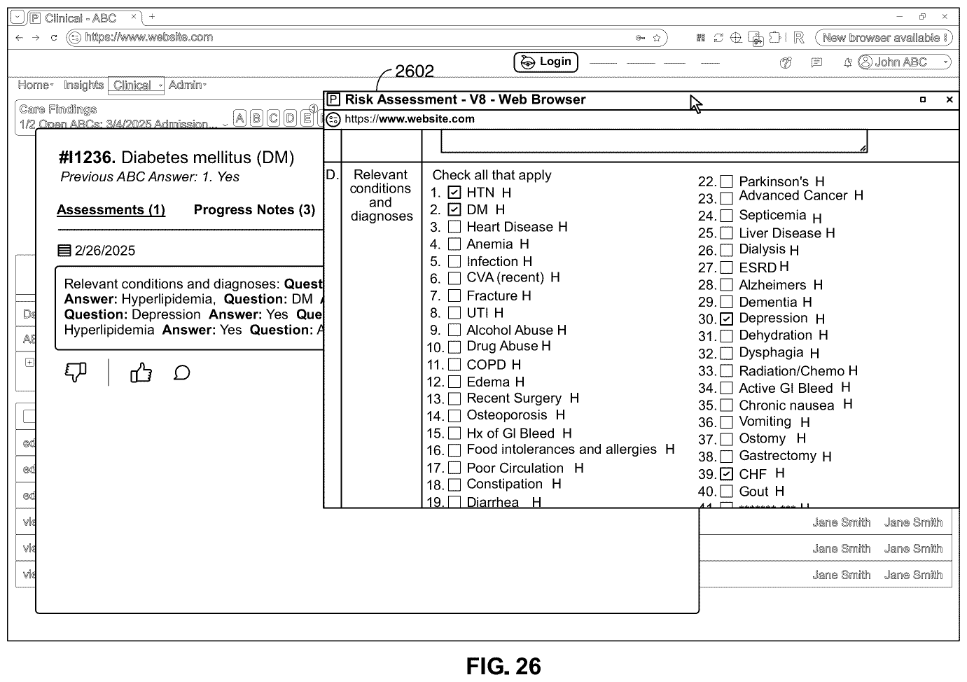

FIG. 26 shows an illustrative diagram. The illustrative diagram shows an exemplary interactive document 2602.

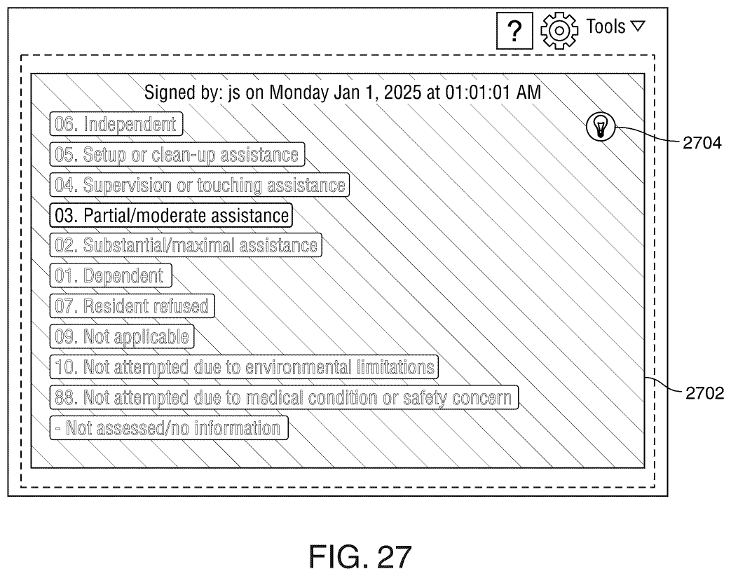

FIG. 27 shows an illustrative diagram. The illustrative diagram shows a subsection of an interactive document. A fillable option may include one or more selectable responses. As shown in fillable option 2702, an operator may select one of multiple selectable responses. In order to enable the operator to select an appropriate response, the operator may be able to select icon 2704. It should be noted that icon 2704 may not be adjacent to a specific answer. Rather, icon 2704 may direct the operator to additional information displayed on a secondary display. Failing to display icon 2704 adjacent to a specific answer may compel the operator to view the additional information.

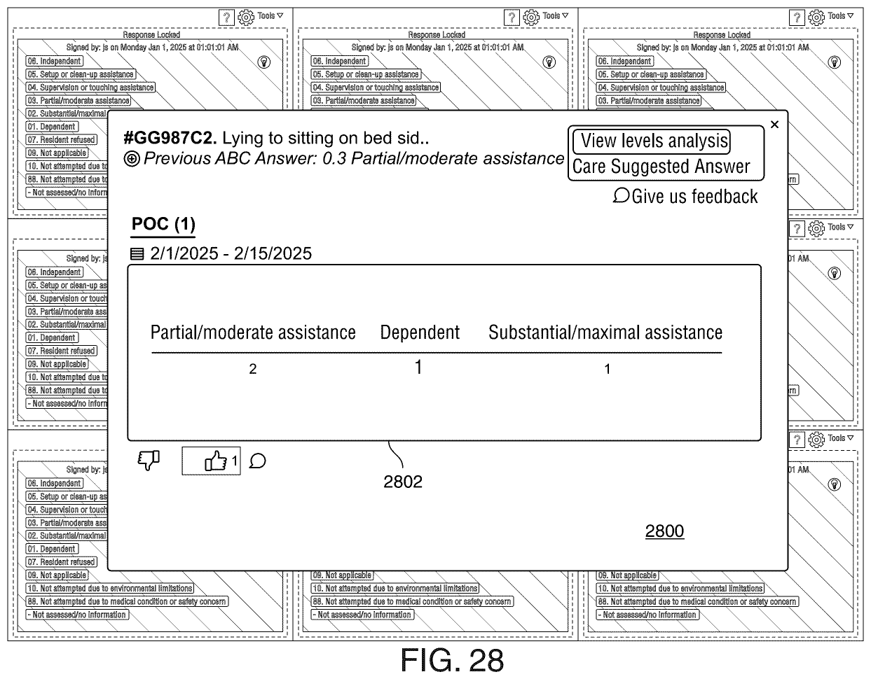

FIG. 28 shows an illustrative diagram. The illustrative diagram may show a secondary, or pop-up, display 2800. Secondary display 2800 may be instantiated upon selection of icon 2704 shown in FIG. 27. Secondary display 2800 may include a levels analysis, shown at 2802. The levels analysis may display a number of times the subject, such as for example, a resident of a skilled nursing facility, attained each of the levels. The information provided in secondary display 2800 may enable the operator to select a response from the selectable responses displayed within 2702.

It should be noted that there may be one or more source documents (not shown) that enable the operator to view the source for each level indicated within the levels analysis. The source documents may be scanned for level indicators at a predetermined time period, for example, after three days of being admitted to a skilled nursing facility.

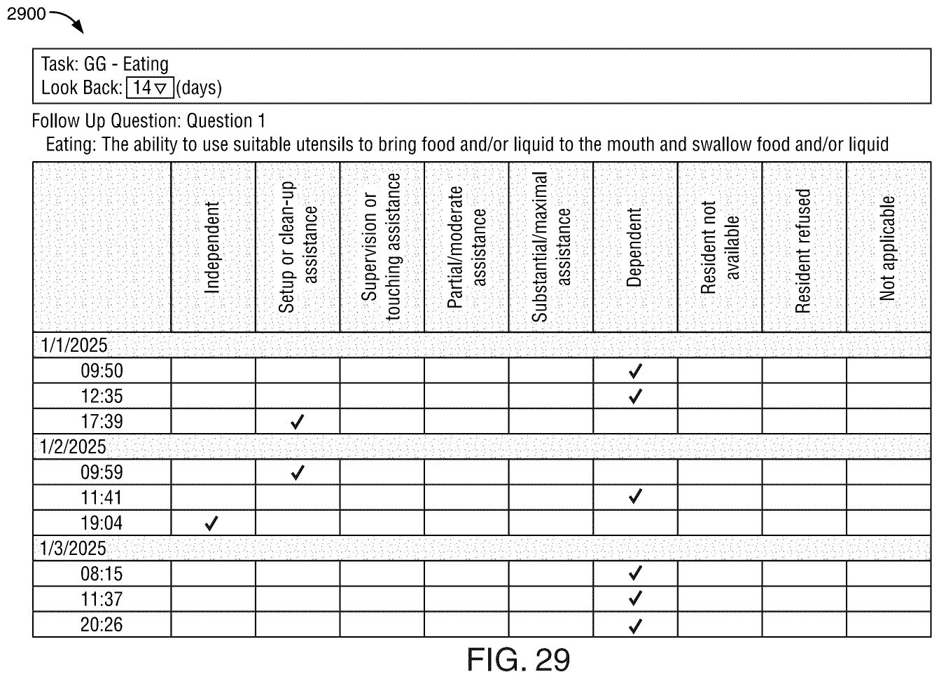

FIG. 29 shows an illustrative diagram. The illustrative diagram shows table 2900. Table 2900 may include each of the levels shown in 2702 and indicators of each of those levels analysis displayed within secondary display 2800.

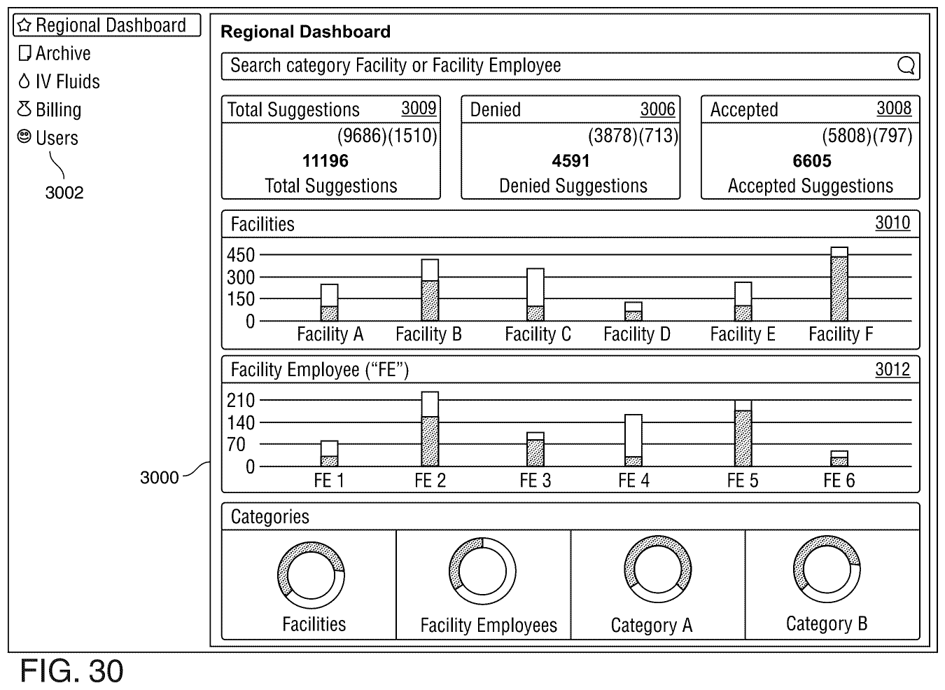

FIG. 30 shows an illustrative diagram. The illustrative diagram shows dashboard 3000. Dashboard 3000 may be instantiated by selecting a dashboard selection within column 3002. It should be noted that dashboard 3000 may be powered by data stored within a database. The data stored within the database may be received at the database from data entered via the browser extension application executing on one or more browsers.

Dashboard 3000 may provide information to a manager regarding the use of the browser extension application within an environment, such as, for example, a skilled nursing facility environment. Dashboard 3000 may display statistical information. The statistical information may include a total number of suggestions displayed within the browser extension application (shown at 3004), a total number of the suggestions denied (shown at 3006) and a total number of suggestions accepted (shown at 3008). A first visual indicator may show suggestions that have been accepted and a second visual indicator may show suggestions that have been denied.

The statistical information may also include information relating to each of a plurality of facilities (shown at 3000). Each facility may be shown as including both the first and second visual indicator. The statistical information may also include information relating to each of a plurality of facility members (shown at 3012). Each facility member may be shown as including both the first and second visual indicator. The statistical information may also include information relating to each of a plurality of categories. Each category may be shown as including the first and second visual indicator. It should be noted that each facility, facility member and/or category may be selectable, and the information displayed on the dashboard may be dynamically adjusted for the selected facility/facility member/category.

Dashboard 3000 may also include the ability for a facility member, such as, for example, a manager to view chat information and/or data shown in feedback column 1608. The manager may be able to communicate with multiple users from within dashboard 3000.

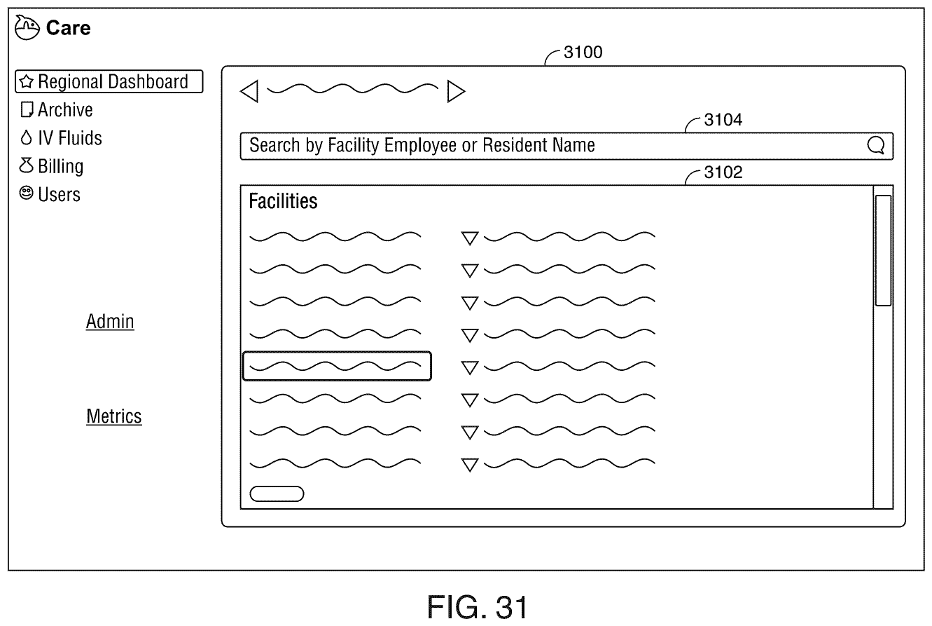

FIG. 31 shows an illustrative diagram. The illustrative diagram shows display view 3100. Display view 3100 may display data for a group of facilities. A list of facilities may be displayed as shown at 3102. An operator of display view 3100 may be able to search for a specific facility employee or resident within search entry field 3104.

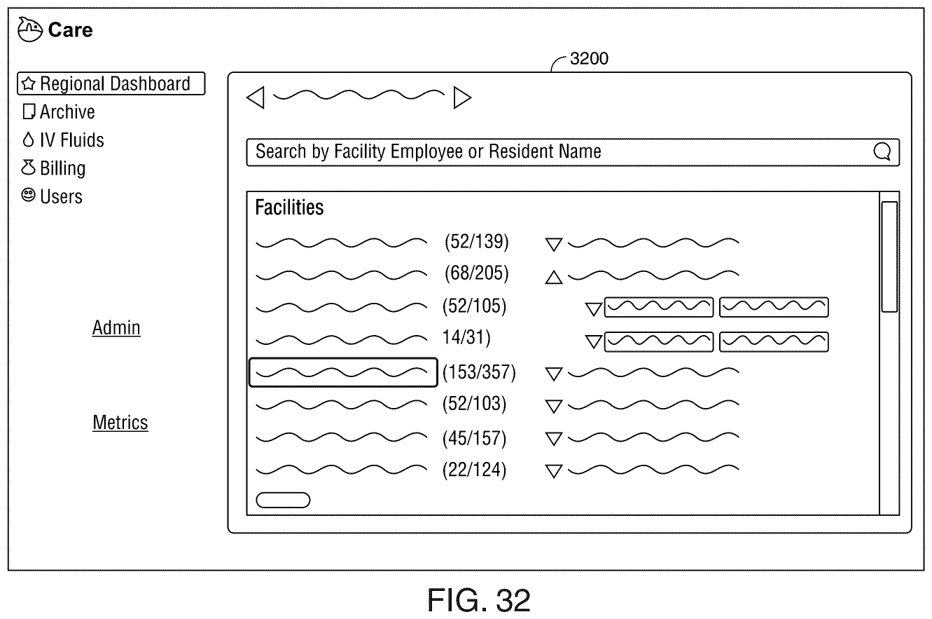

FIG. 32 shows an illustrative diagram. The illustrative diagram shows display 3200. Display 3200 may display data. The data may include a plurality of residents. Each displayed resident may be selectable. Upon selection of a resident, a display specific to the resident and associated assessment may be displayed.

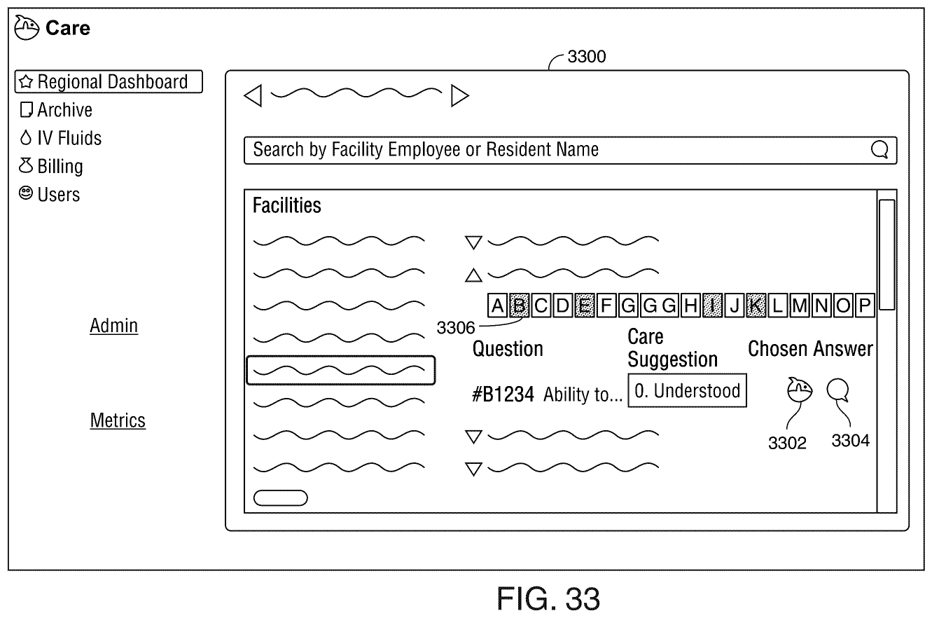

FIG. 33 shows an illustrative diagram. The illustrative diagram shows display 3300. Display 3300 shows an assessment. The displayed assessment includes assessment fillable options in addition to the answer selected by the AI engine, the fillable option selected by the operator and the source (which may be opened by selection of icon 3302). Speech bubble icon 3304 may open a feedback column for the associated source document, which may enable the manager to provide feedback or communicate with the other user, such as, for example, the facility employee. The fillable options may be divided by assessment section. Each section fillable options may be accessed by selecting the section header, such as for example, section header 3306. It should be noted that sections with displayable data may be visually displayed—e.g., with a different color—than those without displayable data.

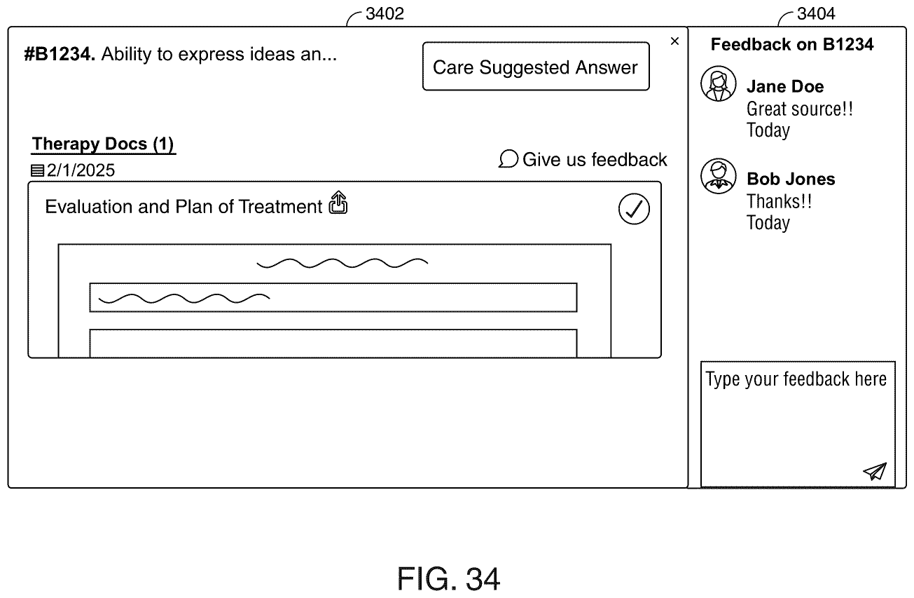

FIG. 34 shows an illustrative diagram. The illustrative diagram shows source popup window 3402. Source popup window 3402 may be a similar display for both a facility employee and a manager. Source popup window may enable facility members and managers to provide feedback to a source, as shown within feedback column 3404.

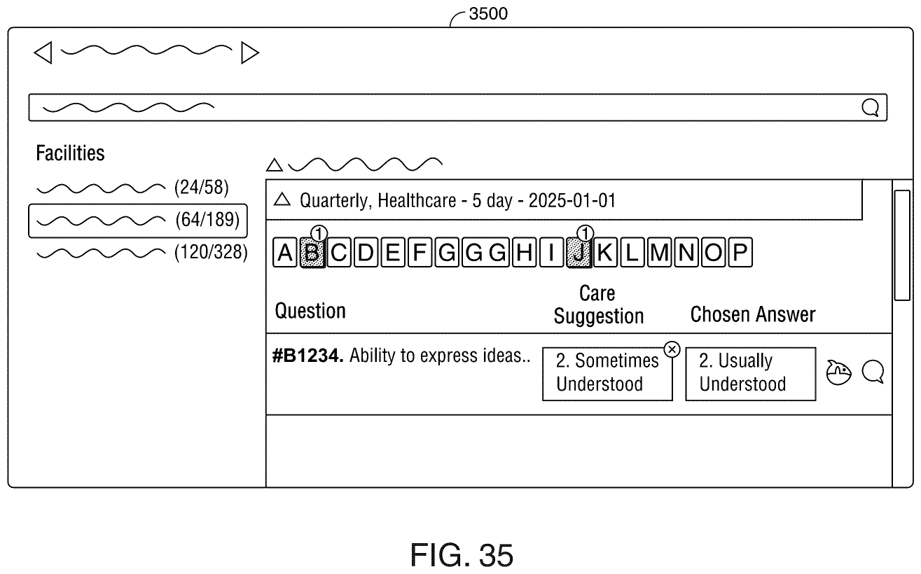

FIG. 35 shows another illustrative diagram. The illustrative diagram shows display 3500. Display 3500 may include an interactive document/assessment. Display 3500 may be a manager-view of the interactive document/assessment.

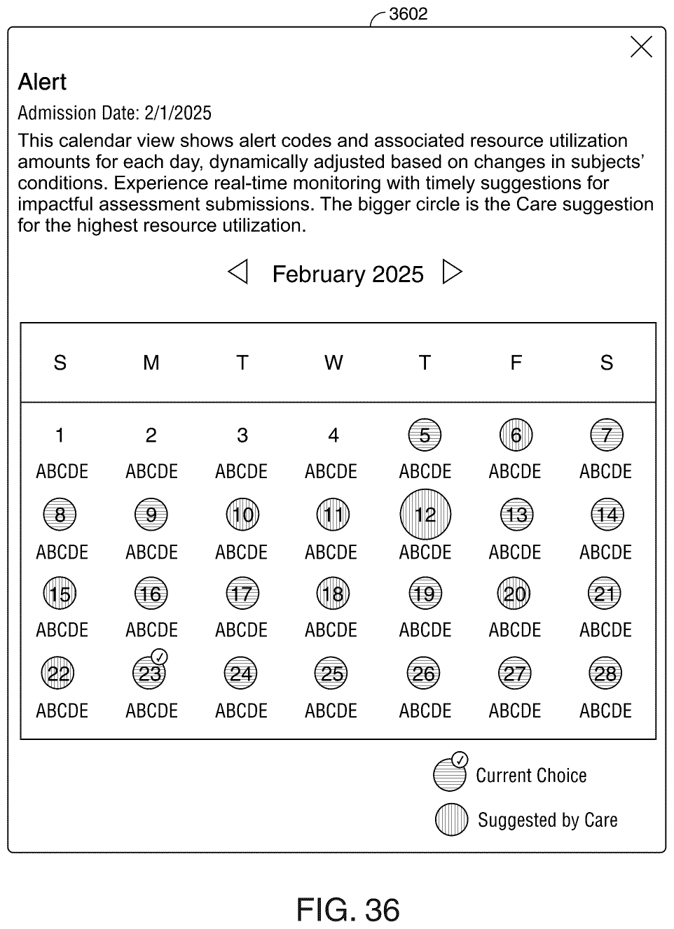

FIG. 36 shows an illustrative diagram. The illustrative diagram shows an AI-based calendar 3602. The calendar recommends a reference date for an assessment. The reference date for an assessment may be a date that determines an assessment lookback time period. The lookback time period may be date range, such as, for example 14 days, in which to retrieve documented predetermined information segments, such as, for example, conditions, that may be used to input into the assessment.

Modification of the reference date may modify the lookback period to retrieve documented information segments that can be input into the assessment. Resource consumption may be based on data input into the assessment. As such, modification of the reference date may modify the resource consumption.

The AI-based calendar may scan source documents over a range of days surrounding a reference date, indicated by an operator or a system, for an in-progress assessment. The AI-based calendar determined an alert score for each day based on the information segments located in the source documents for a specific lookback period determined by the reference date. The AI-based calendar displays the dates surrounding the reference date indicated by the operator or system with larger, darker circles indicating a reference date with a higher resource consumption.

It should be noted that a predicted resource consumption rate and suggested reference date may be shown in an interactive document/assessment displayed in a browser. Selecting, or hovering over, a calendar icon displayed in the browser may open the AI-based calendar 3602. Selecting, or hovering over, a predicted resource consumption rate may open an alert popup.

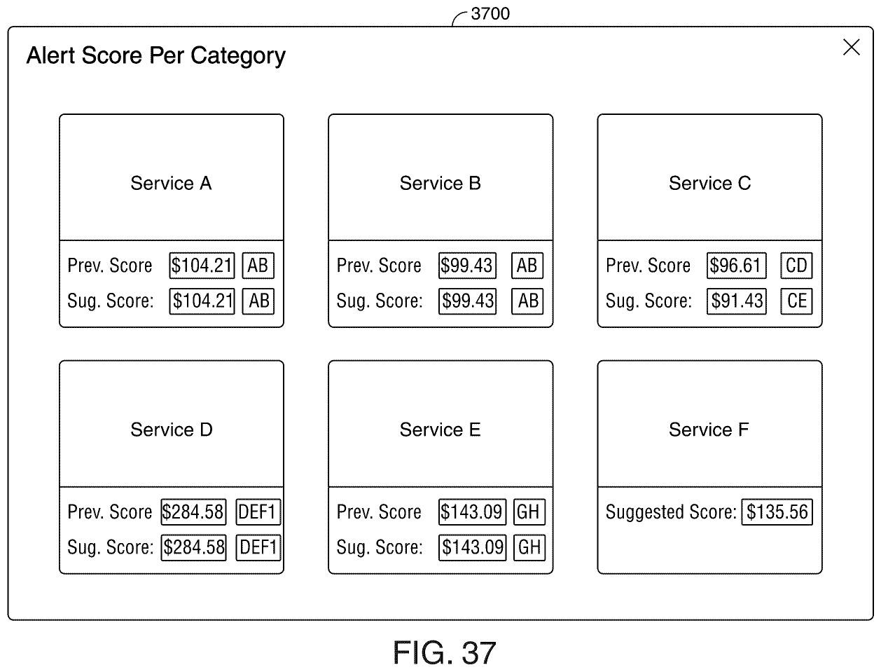

FIG. 37 shows an illustrative diagram. The illustrative diagram shows an alert pop-up 3700. The alert popup may display the projected alert score for the reference date that the AI engine determined to have the highest resource consumption rate. Alert pop-up 3700 shows the alert score broken down into component parts.

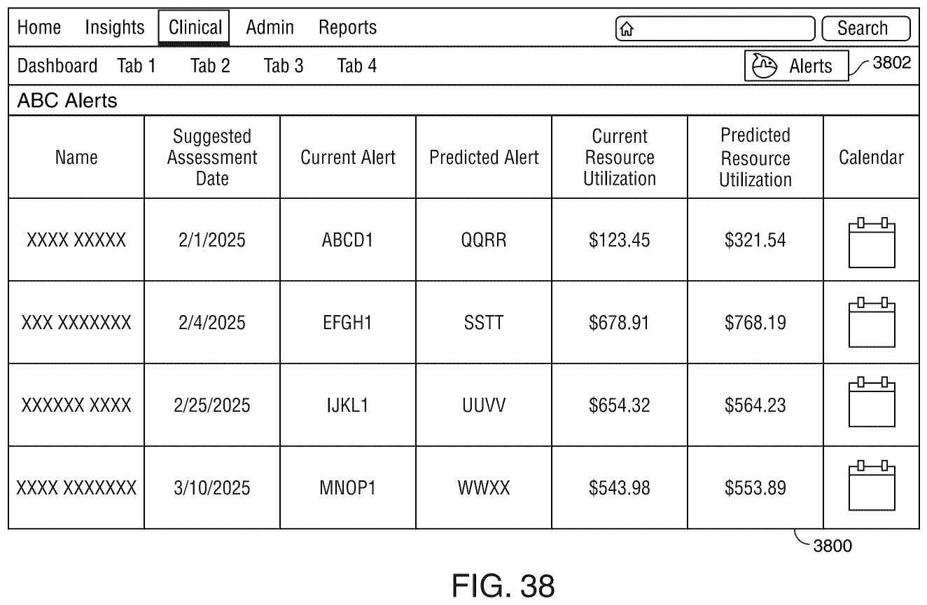

FIG. 38 shows an illustrative diagram. The illustrative diagram may include display 3800. Display 3800 may include alerts tab 3802.

An alert may be displayed to indicate that a secondary interactive document is worthwhile to execute for a specific subject, such as, for example, a skilled nursing facility resident, because the secondary interactive document would increase resource consumption associated with the specific subject. Display 3800 may display a current resource consumption level and a predicted resource consumption level if the secondary interactive document would be completed.

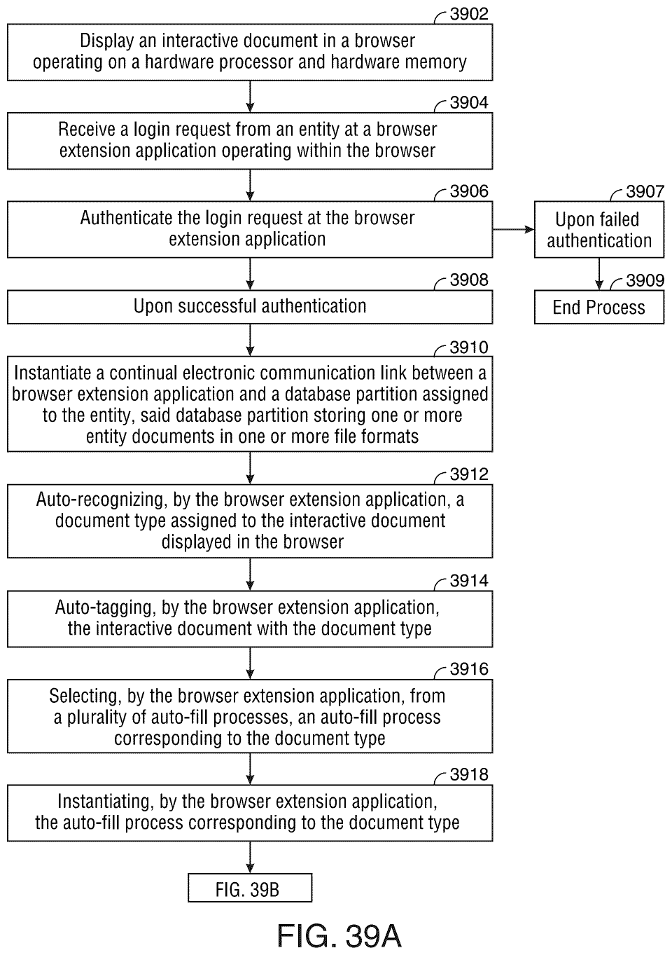

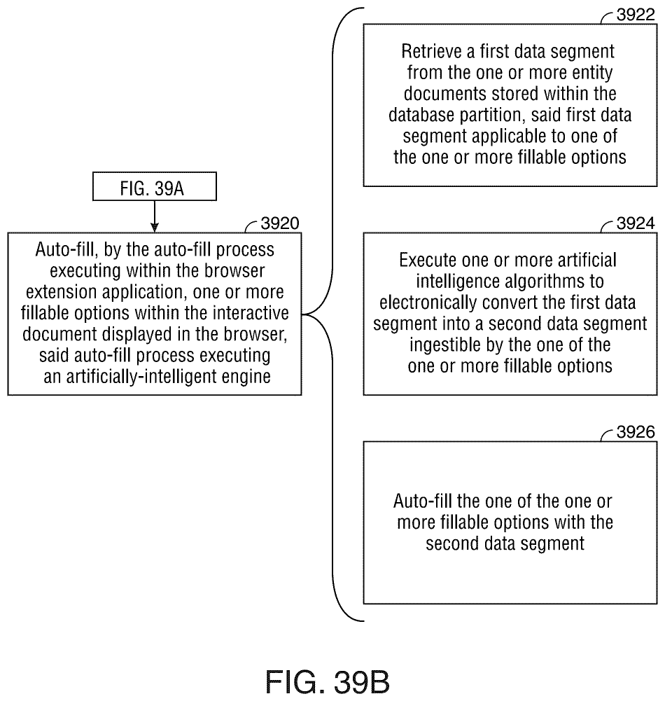

FIGS. 39A and 39B show an illustrative flow chart. The flow chart shows an illustrative process of autofilling an interactive document. Step 3902 shows displaying an interactive document in a browser operating on a hardware processor and hardware memory. Step 3904 shows receiving a login request from an entity at a browser extension application operating within the browser.

Step 3906 shows authenticating the login request at the browser extension application. Failed authentication may end the process, as shown at steps 3907 and 3909.

Successful authentication may be shown at 3908. As shown at step 3910, a continual electronic communication may be instantiated between the browser extension application and a database partition assigned to the entity. The database partition may store one or more entity documents in one or more file formats.

The browser extension application may autorecognize a document type assigned to the interactive document displayed in the browser, as shown at step 3912. The browser extension application may autotag the interactive document with the document type, as shown at step 3914. The browser extension application may select from a plurality of autofill processes, an autofill process corresponding to the document type, as shown at step 3916. The browser extension application may instantiate the autofill process corresponding to the document type, as shown at step 3918.

The browser extension application may autofill one or more fillable options within the interactive document, as shown at step 3920. The autofill process may execute an artificial intelligence engine.

The autofill process may include retrieving a first data segment from the one or more entity documents, as shown at step 3922. The first data segment may be applicable to one of the fillable options.

The autofill process may include executing one or more AI algorithms or models to electronically convert the first data segment into a second data segment, as shown at step 3924. The second data segment may be ingestible by the one of the fillable options.

The autofill process may include autofilling the one of the fillable options with the second data segment, as shown at step 3926.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

Thus, systems and methods for AI-based autofill for document preparation are provided. Persons skilled in the art will appreciate that the present invention can be practiced by other than the described embodiments, which are presented for purposes of illustration rather than of limitation.

What is claimed is:

1. A front-end process flow for an artificial-intelligence (“AI”)-based autofill for document preparation, said front-end process flow comprising:
displaying an interactive document in a browser operating on a hardware processor and hardware memory;
receiving a login request from an entity at a browser extension application operating within the browser;
authenticating the login request at the browser extension application; and
upon successful authentication:
instantiating a continual electronic communication link between the browser extension application and a database partition assigned to the entity, said database partition storing one or more entity documents in one or more file formats;
auto-recognizing, by the browser extension application, a document type assigned to the interactive document displayed in the browser;
auto-tagging, by the browser extension application, the interactive document with the document type;
selecting, by the browser extension application, from a plurality of autofill processes, an autofill process corresponding to the document type;
instantiating, by the browser extension application, the autofill process corresponding to the document type; and
autofilling, by the autofill process executing within the browser extension application, one or more fillable options within the interactive document displayed in the browser, said autofill process executing an artificial-intelligence engine, said executing the artificial-intelligence engine comprising:
retrieving a first data segment from the one or more entity documents stored within the database partition, said first data segment applicable to one of the one or more fillable options;
executing one or more artificial intelligence algorithms to electronically convert the first data segment into a second data segment ingestible by the one or more fillable options; and
autofilling the one of the one or more fillable options with the second data segment.

2. The front-end process flow of claim 1 wherein the interactive document is an assessment.

3. The front-end process flow of claim 1 wherein the interactive document requires input by the entity for completion.

4. The front-end process flow of claim 1 wherein the autofilling the one of the one or more fillable options with the second data segment requires electronic approval of the second data segment.

5. The front-end process flow of claim 1 wherein the browser extension application displays, adjacent to the one or more fillable options, a selectable option for a pop-up window corresponding to the first data segment, said pop-up window showing a correlation between the first data segment and the second data segment.

6. The front-end process flow of claim 5 further comprising:
retrieving the one or more entity documents; and
displaying the one or more entity documents within the pop-up window.

7. The front-end process flow of claim 6 further comprising converting the one or more entity documents into a second interactive document, said second interactive document comprising:
one or more indicators to the first data segment; and
one or more toggle options to auto-reposition the second interactive document to display the one or more indicators.

8. The front-end process flow of claim 7 wherein:
upon electronic perusing of the second interactive document, said electronic perusing comprising at least one electronic auto-reposition of the second interactive document, the second interactive document enables selection of an electronic reviewed selectable option, said electronic reviewed selectable option indicating that the second interactive document has been approved for the first data segment; and
upon selection of the electronic reviewed selectable option, the second interactive document includes a second indicator, said second indicator displayed when the second interactive document is displayed in a second pop-up window for a second of the one or more fillable options.

9. The front-end process flow of claim 6 wherein the autofilling the one or more fillable options with the second data segment is triggered upon:
the selection of the selectable option for the pop-up window; and
the displaying the one or more entity documents within the pop-up window.

10. The front-end process flow of claim 1 wherein, upon autofilling one of the one or more fillable options, an indicator adjacent to the one or more fillable options is auto-generated.

11. The front-end process flow of claim 10 wherein:
the indicator displays an icon, said icon selected from a plurality of stored icons; and
selection of the icon is based on a confidence score assigned by the artificial-intelligence engine to the autofilling of the one of the one or more fillable options.

12. The front-end process flow of claim 11 wherein the icon includes a hover-over capability, when triggered by a mouse hover, displays textual information relating to the selected icon.

13. The front-end process flow of claim 1 wherein:
the first data segment indicates less than an information threshold of relevance to the one of the one or more fillable options; and
the second data segment is a negative answer.

14. An artificial intelligence (“AI”)-based autofill system for document preparation, the system comprising:
a browser operating on a hardware processor and a hardware memory, the browser operable to display an interactive document; and
a browser extension application operating within the browser, the browser extension application operable to:
receive a login request from an entity;
authenticate the login request;
instantiate a continual electronic communication link to a database partition assigned to the entity, the database partition storing one or more entity documents in one or more file formats;
auto-recognize a document type assigned to the interactive document displayed in the browser;
select an autofill process corresponding to the document type; and
instantiate the autofill process, said autofill process comprising execution of an artificial intelligence engine to autofill a plurality of fillable options within the interactive document, said execution of the artificial intelligence engine comprising:
retrieval of a first data segment from the one or more entity documents stored within the database partition, said first data segment applicable to at least one fillable option included in the plurality of fillable options;
execution of one or more artificial intelligence algorithms to electronically convert the first data segment into a second data segment, said second data segment ingestible by the at least one fillable option; and
autofilling of the at least one fillable option with the second data segment.

15. The AI-based autofill system for document preparation of claim 14 wherein the interactive document is an assessment.

16. The AI-based autofill system for document preparation of claim 14 wherein the interactive document requires input by the entity for completion.

17. The AI-based autofill system for document preparation of claim 14 wherein the autofill executed by the artificial intelligence engine requires electronic approval of the second data element.

18. The AI-based autofill system for document preparation of claim 14 wherein the browser extension application is further operable to display, adjacent to the at least one fillable option, a selectable option for a pop-up window corresponding to the first data segment, the pop-up window showing a correlation between the first data segment and the second data segment.

19. The AI-based autofill system for document preparation of claim 18 wherein the browser extension application is further operable to:
retrieve the one or more entity documents; and
display the one or more entity documents within the pop-up window.

20. The AI-based autofill system for document preparation of claim 19 wherein the browser extension application is further operable to convert the one or more entity documents into one or more interactive entity documents, said one or more interactive entity documents comprises:
one or more indicators to the first data segment; and
one or more toggle options, when selected auto-reposition the one or more interactive entity documents to display the one or more indicators.

21. The AI-based autofill system for document preparation of claim 20 wherein:
upon electronic perusal of the one or more interactive entity documents, said electronic perusal comprising at least one electronic auto-reposition of the one or more interactive entity documents, the one or more interactive entity documents enables selection of an electronic reviewed selectable option, when selected, the electronic reviewed selectable option indicates approval of the one or more interactive entity documents for the first data segment; and
upon selection of the electronic reviewed selectable option, the one or more interactive entity documents displays an indicator, the indicator displayed when the one or more interactive entity documents are displayed in a second pop-up window for a second fillable option included in the plurality of fillable options.

22. The AI-based autofill system for document preparation of claim 19, wherein the autofill the at least one fillable option is triggered upon:
the selection of the selectable option for the pop-up window; and
the display the one or more entity documents within the pop-up window.

23. The AI-based autofill system for document preparation of claim 14 wherein the browser extension application is further operable to auto-generate at least one option upon the autofill the at least one fillable option with the second data segment.

24. The AI-based autofill system for document preparation of claim 23 wherein:
the indicator displays an icon adjacent to the at least one fillable option; and
the icon is selected from a plurality of stored icons, said selection based on a confidence score assigned by the artificial intelligence engine to a correlation between the second data segment and the at least one fillable option.

25. The AI-based autofill system for document preparation of claim 24 wherein the icon includes a hover-over capability, when triggered by a mouse hover, displays textual information relating to the icon.

26. The AI-based autofill system for document preparation of claim 14 wherein:
the first data segment indicates less than an information threshold of relevance to the at least one fillable option; and
the second data segment is a negative answer.

27. A front-end process flow for an artificial-intelligence (“AI”)-based auto-selection for document preparation, said front-end process flow comprising:
receiving, at a user interface, a request from an operator to identify one or more time windows in which a document associated with a subject should be completed to maximize resource consumption associated with the document;
electronically perusing, using an AI engine communicating with a database, a plurality of electronic documents stored in the database, said plurality of electronic documents associated with the subject, for one or more instances relating to one or more specific data elements;
upon identification, within the plurality of electronic documents, of the one or more instances relating to the one or more specific data elements, generating, using the AI engine, a list data structure, said list data structure comprising, for each of the one or more specific data elements:
the one or more instances relating to each specific data element included in the one or more specific data elements; and
a timestamp associated with each of the one or more instances; and
based on the list data structure, dynamically generating an electronic calendar, said electronic calendar comprising one or more indicators corresponding to the one or more time windows in which the document associated with the subject should be completed to maximize resource consumption.

28. The front-end process flow of claim 27 wherein the one or more time windows are dates.

29. The front-end process flow of claim 27 wherein electronic calendar is displayed on the user interface.

30. The front-end process flow of claim 27 further comprising auto-selecting, by the AI engine, the one or more time windows in which the document associated with the subject should be completed to maximize resource consumption.
